(19) United States
(12) Patent Application Publication
(10) Pub. No.: US 2009/0178876 A1
(43) Pub. Date: Jul. 16, 2009

(54) Controlling apparatus and vehicle provided therewith

(75) Inventors: Nobuaki Miki, Tokyo (JP); Munehisa Horiguchi, Tokyo (JP); Manabu Matsuda, Tokyo (JP); Seiichi Takeda, Tokyo (JP)

Correspondence Address: BACON & THOMAS, PLLC, 625 SLATERS LANE, FOURTH FLOOR, ALEXANDRIA, VA, 22314-1176, US

(73) Assignee: KABUSHIKIKAISHA EQUOS RESEARCH, Tokyo (JP)

(21) Appl. No.: 11/918,653

(22) PCT Filed: Apr. 24, 2006
(86) PCT No.: PCT/JP2006/308561

§ 371 Date: Dec. 10, 2008

(30) Foreign Application Priority Data
Apr. 28, 2005 (JP) 2005-133521
Jul. 29, 2005 (JP) 2005-220513

(51) Int. Cl. B62D 9/00; B62D 6/00; G01C 21/00

(52) U.S. Cl. 180/411; 701/41; 701/208

(57) ABSTRACT

A control device capable of moving a vehicle in a direction with an angle larger than at least the maximum steering angle of wheels. When the wheels (2) are brought into a parallel movement arrangement as shown in FIG. 3(a) and rotatingly driven according to the depressed amount of an accelerator pedal (53), the wheels (2) are slippingly moved on a road surface. Thus, while the vehicle forward component of a drive force generated by the right and left front wheels (2FR) and (2FL) and the vehicle rearward component of a drive force generated by the right and left rear wheels (2RR) and (2RL) balance each other out, the vehicle rightward component of a drive force generated by the right and left front wheels (2FR) and (2FL) and the vehicle rightward component of a drive force generated by the right and left rear wheels (2RR) and (2RL) act as a drive force for moving the vehicle (1) rightward. As a result, the vehicle (1) can be moved, in parallel, in the right side direction of the vehicle.

### INCORPORATION BY REFERENCE

The disclosure of Japanese Patent Application No. 2006-308561 filed on Apr. 24, 2006 including the specification, drawings and abstract is incorporated herein by reference in its entirety.

### BACKGROUND OF THE INVENTION

1. Field of the Invention

The present invention relates to a controlling apparatus that controls a vehicle having a plurality of steerable wheels, an actuator unit that drives to steer each of the steerable wheels independently, and a wheel driving unit that drives to rotate each of the steerable wheels independently, to move the vehicle in a given direction by operating the actuator unit and the wheel driving unit to control steering and rotation of the steerable wheels, and also relates to a vehicle having the controlling apparatus. The present invention also relates to a controlling apparatus that controls a vehicle having steerable wheels and an actuator unit that steers the steerable wheels, to control steering of the steerable wheels by driving the actuator unit, and more particularly to drive the vehicle to make a turn appropriately depending on the environment surrounding the vehicle, and also relates to a vehicle having such a controlling apparatus.

2. Description of the Related Art

Parallel parking is generally achieved by a sequence of operations including a driver backing up a vehicle in parallel to the road, turning the steering wheel when the rear end of the vehicle becomes roughly parallel with the edge of the parking space, then as the rear end of the vehicle enters the parking space, turning the steering wheel in the reverse direction to position and park the vehicle in the targeted parking space.

Parallel parking requires some driving skill, and is difficult for an inexperienced driver to judge when to start turning the steering wheel and how much to turn, or at what point to start turning the steering wheel in the reverse direction.

Various technologies have been developed to aid parallel parking. For example, Japanese Patent Application Publication No. JP-A-2001-180407 discloses a driver-aid apparatus including a camera, a display monitor arranged in a position that is visually recognizable by the driver, and a display controlling unit. According to the disclosure, the camera captures an image of the rear end of the vehicle on which the apparatus is mounted, the captured image is displayed on the monitor, and guiding information is superimposed over the image on the monitor by the display controlling unit so to aid the driver.

According to this technology, because the guiding information is displayed on the monitor, such as marks indicating how much the steering wheel is actually turned and how much it should be turned, and a mark indicating where to turn the steering wheel in the reverse direction, the driver can just follow the guiding information on the monitor, easily understanding when and how much to turn the steering wheel.

However, it is a driver-aid technology and is not intended to improve a steering capability of the vehicle itself. Therefore, as shown in FIG. 15A, when a road width, or a spacing in the front or back of the vehicle in the parking space is extremely limited, the vehicle could bump into a parked car or other obstacles upon entering the parking space, or get stuck in the parking space. Furthermore, the driver may be unable to fit the entire vehicle body into the parking space with a part of the vehicle sticking out, thus being an obstacle for other incoming vehicles.

The inventors of the present inventions have made extensive investigations to solve these problems, and developed a technology using a mechanism that allows horizontal movement of wheels (that is, with a steered angle of 90 degrees), as shown in FIG. 15B. According to this technology, a vehicle can be parallel-moved in the lateral (right and left) directions. Therefore, the driver can parallel park the vehicle easily, even when a road width or a spacing in the front or back of the vehicle in the parking space is extremely limited.

Currently, upon making a turn with a generally available passenger vehicle, only a turn within a limited radius can be made, because the steering mechanism thereof determines the maximum steerable angle of two front wheels or four front and rear wheels. Therefore, if there is not enough space, the steering wheel will need to be turned back and forth many times to change the orientation of the vehicle, or sometimes it will become impossible to turn the vehicle.

With reference to FIGS. 25A, 26A, 27A, and 28A, various scenarios for moving a vehicle out of a parking lot are explained by way of example. A driver is attempting to move a vehicle 100 of a standard size (length 4,795 millimeters×width 1,790 millimeters×height 1,770 millimeters) out from a parking space 110 (width 2.3 meters×length 5.0 meters) into a driveway 120 (width 5.5 meters) that is perpendicular to the parking space 110, by operating the steering wheel and the gas pedal.

FIG. 25A is a diagram for showing the vehicle 100 turning left in the forward direction around a turning axis A1 with a minimum radius of 5.8 meters. In this example, the vehicle 100 scrapes against a wall 120a standing along the side of the driveway 120 across the parking space 110. Therefore, the steering wheel must be turned back and forth multiple times to avoid scraping the wall 120a.

FIG. 26A is a diagram for showing the vehicle 100 turning left in the forward direction around a turning axis B1 with a minimum radius of 5.8 meters to avoid bumping into a vehicle 140 parked in front thereof. In this example, the vehicle 100 runs across a parking space adjacent to the parking space 110, and will scrape against a vehicle 130 parked in the adjacent parking space.

FIG. 27A is a diagram for showing the vehicle 100 turning left in the forward direction around a turning axis C1 with a minimum radius of 5.8 meters to avoid scraping against the vehicle 130 parked in the parking space adjacent to the parking space 110. However, if a vehicle 140 is parked in front thereof, the vehicle 100 will scrape against the vehicle 140 as shown in FIG. 27A.

FIG. 28A is a diagram for showing another example where a driver is attempting to turn the vehicle 100 to the left in the forward direction to avoid clipping the edge of the opening 170a on a curb 170 and enter a roadway 160 having one lane in each direction by operating the steering wheel and the gas pedal.

In FIG. 28A, the vehicle 100 is turned into the leftward lane of the roadway 160 with a turning axis D1 with a minimum radius of 5.8 meters to avoid scraping the opening 170a. If the lane width (the width of the one-way lane with a boundary at a center line 180) is limited, the vehicle 100 overruns the center line 180 at some moment upon turning. It is very dangerous for the vehicle 100 to overrun the center line 180 upon turning, because the vehicle 100 can collide with a vehicle 150 coming from the opposite direction.

As explained above, depending on the surrounding environment, there are many situations where a driver experiences difficulty in making a turn with the conventional vehicle 100 with a limited radius. In order to overcome the difficulty, Japanese Patent Application Publication No. JP-A-2003-146234, for example, discloses a controlling apparatus for an electric vehicle having four wheels at the right front, the left front, the right rear, and the left rear steered and driven by independent steering motors and driving motors upon making a turn, in accordance with limiting conditions (road conditions that greatly influence steering and driving of a vehicle) that are unique to facilities along roadways.

In the controlling apparatus disclosed in the Japanese Patent Application Publication No. JP-A-2003-146234, a driver selects a steering mode from a plurality of steering modes having different overall patterns including various swept paths of each wheel, and sets a driving speed and a direction. Then, the steering angle and the rotation speed of each wheel are controlled by a conditional equation that is suited for steering and driving (rotation) according to the steering mode selected by the driver.

However, the above technology (the mechanism that allows wheels to be steered by 90 degrees) is found difficult to achieve in reality due to the following limitations.

To make the wheels steerable by 90 degrees, a more complex linking mechanism is required to steer the wheels. This results in an increase in weight or a decrease in durability. Another problem is that, to make the wheels steerable by 90 degrees, electrical cabling and hydraulic piping become complicated, and interferences and repeated stresses during steering become unavoidable. This, in turn, results in lower reliability.

In addition, to give a steering angle of 90 degrees to the wheels, it is necessary to increase the operation amount of the known actuator. Therefore, the size of the actuator increases, further increasing weight and parts cost thereof. Furthermore, to make the wheels steerable by 90 degrees, a large space is required for moving the steered wheels; therefore, ensuring such a required space within the vehicle becomes another issue.

Considering these problems, a steering angle which can be given to each wheel is limited to approximately 45 degrees. With such a limited steering angle, only a movement such as one shown in FIG. 15C is possible. This cannot be considered as an effective solution to the difficulty in parallel parking. In other words, the related-art technologies do not allow the vehicle 100 to be turned at an angle that is larger than the maximum angle at which the wheels can be steered.

Furthermore, in a controlling apparatus, such as in one disclosed in Japanese Patent Application Publication No. JP-A-2001-180407, each wheel is steered and driven under a control triggered by the driver selecting the steering mode or setting the driving speed or direction. However, because extremely complex and delicate operations are required to turn a vehicle by steering and rotating the wheels independently, a human error could result in an accident (scraping or collision).

For example, because the driver selects one steering mode from a plurality of steering modes, there is a chance that the driver chooses an inappropriate steering mode. In addition, if the driver is not sufficiently aware of the surroundings, the driver would choose a wrong steering mode, or an incorrect driving speed or direction. As a result, the controlling apparatus of the Japanese Patent Application Publication No. JP-A-2001-180407 ends up controlling the electric vehicle inappropriately, possibly causing an accident of the vehicle.

Furthermore, the controlling apparatus disclosed in the Japanese Patent Application Publication No. JP-A-2001-180407 requires a driver operation. Therefore, the driver is required to follow cumbersome procedures, such as selecting a steering mode out of a plurality of steering modes, and must be careful to avoid misoperations, which imposes a psychological burden.

### SUMMARY OF THE INVENTION

In view of the foregoing, an advantage of some aspects of the present invention is to provide a controlling apparatus that enables a vehicle to be turned in an angle that is at least larger than the maximum angle at which the wheels can be steered, and also to provide a vehicle having the controlling apparatus. Taking the problems described above into account, another advantage of some aspects of the present invention is to provide a controlling apparatus that drives a vehicle to make an appropriate turn depending on the surrounding environment without requiring a driver to follow cumbersome procedures, and also to provide a vehicle having such a controlling apparatus.

In view of the foregoing, a controlling apparatus according to a first aspect of the present invention controls a vehicle having a plurality of steerable wheels, an actuator unit that drives to steer each of the steerable wheels independently, and a wheel driving unit that drives to rotate each of the steerable wheels independently, the vehicle being moved in a given direction by operating the actuator unit and the wheel driving unit controlling steering and rotation of the steerable wheels, and the controlling apparatus includes: a first operating section that operates the actuator unit so as to give at least one of the steerable wheels a steering angle; and a second operating section that operates the wheel driving unit so as to drive to rotate at least two of the steerable wheels including the wheel to which the steering angle is given, and rotate at least one of the steerable wheels in a forward direction, and at least another of the steerable wheels in a reverse direction. The vehicle is controlled to move in a direction toward an angle that is at least larger than the maximum steerable angle of the wheels by combining a longitudinal vector component and a lateral vector component of a driving force generated by driving to rotate the wheels.

According to a second aspect of the present invention, in the controlling apparatus according to the first aspect, the second operating section operates the wheel driving unit so that a sum of the lateral vector component of the driving force generated by at least two of the wheels that are driven to rotate by the wheel driving unit exceeds 0, and a sum of the longitudinal vector component thereof becomes 0.

According to a third aspect of the present invention, in the controlling apparatus according to the first or second aspect, the steerable wheels include a front-right wheel, a front-left wheel, a rear-right wheel, and a rear-left wheel; the first operating section operates the actuator unit so as to give at least one of the front-right and front-left wheels and at least one of the rear-right and rear-left wheels an steering angle; and the second operating section operates the wheel driving unit so that the lateral vector component of a driving force generated by the front-right and front-left wheels becomes the same in magnitude and direction as the lateral vector component of a driving force generated by the rear-right and rear-left wheels, and that the longitudinal vector component of a driving force generated by the front-right and front-left wheels becomes the same in magnitude but different in direction as the longitudinal vector component of a driving force generated by the rear-right and rear-left wheels.

According to a fourth aspect of the present invention, in the controlling apparatus according to the first or second aspect,

the steerable wheels include a front-right wheel, a front-left wheel, a rear-right wheel, and a rear-left wheel; the wheel driving unit is driven so that a lateral vector component of a driving force generated by one of either the front-right and front-left wheels or the rear-right and rear-left wheels becomes greater in magnitude in the same or a different direction than a lateral vector component of a driving force generated by the other of either the front-right and front-left wheels or the rear-right and rear-left wheels; a longitudinal vector component of the driving force generated by one of either the front-right and front-left wheels or the rear-right and rear-left wheels becomes greater in magnitude in a different direction than a longitudinal vector component of a driving force generated by the other of either the front-right and front-left wheels or the rear-right and rear-left wheels; and the lateral vector component of the driving force generated by the front-right wheel, the front-left wheel, the rear-right wheel, and the rear-left wheel to spin the vehicle in rotation is cancelled out by the longitudinal vector component of the driving force generated by the front-right wheel, the front-left wheel, the rear-right wheel, and the rear-left the wheel.

According to a fifth aspect of the present invention, the controlling apparatus according to any one of the first to fourth aspects further includes: a detecting section that detects usage frequency of the steerable wheels; a determining section that determines if the usage frequency detected by the detecting section exceeds a reference value; and a prohibiting section that prohibits any wheel whose usage frequency is determined to exceed the reference value by the determining section from being driven in rotation via an operation of the wheel driving unit by the second operation section.

A vehicle according to a sixth aspect of the present invention includes: a plurality of steerable wheels. an actuator unit that steers each of the steerable wheels independently. a wheel driving unit that drives to rotate each of the steerable wheels independently. and the controlling apparatus according to any one of the first to fifth aspects of the present invention.

A controlling apparatus according to a seventh aspect of the present invention that controls an actuator unit that drives to steer a plurality of steerable wheels of a vehicle independently, includes: an environment information obtaining section that obtains information about the environment surrounding the vehicle, a turning pattern searching section that searches a turning axis and a turning pattern for turning the vehicle based on the environment information obtained by the environment information obtaining section, and a turn controlling section that controls the actuator unit so that the vehicle is turned around the turning axis following the turning pattern, both of which are searched by the turning pattern searching section.

According to an eighth aspect of the present invention, the controlling apparatus according to the seventh aspect further includes: a turning pattern storage section that stores a plurality of turning patterns, and a comparing section that compares the turning patterns stored in the turning pattern storage section with the environment information obtained by the environment information obtaining section. The turning pattern searching section searches a turning pattern from the turning pattern storage section based on a comparison result obtained by the comparing section.

According to a ninth aspect of the present invention, the controlling apparatus according to the seventh or eighth aspect further includes: a driver-operated turnability determining section that determines if the vehicle is turnable under the environment information obtained by the environment information obtaining section by steering at least some of the wheels by an angle determined by a driver steering a steering wheel, and by applying a driving force determined by the driver operating a gas pedal to at least some of the wheels, and a search prohibiting section that prohibits the turning pattern searching section from searching the turning axis and the turning pattern when the driver-operated turnablilty determining section determines that the vehicle is turnable by the driver operating the steering wheel and the gas pedal.

According to a tenth aspect of the present invention, the controlling apparatus according to any one of the seventh to ninth aspects further includes: a vehicle position obtaining section that obtains information about the position of the vehicle; a map data storage section that stores therein a map data; a premise-shape recognizing section that recognizes the shape of an area surrounding the vehicle whose position information is obtained by the vehicle position obtaining section, based on the map data stored in the map data storage section; and

a movable area detecting section that detects an area available for the vehicle to track based on the shape of the area recognized by the premise-shape recognizing section. The environment information obtaining section obtains the area detected by the movable area detecting section as the environment information.

According to an eleventh aspect of the present invention, the controlling apparatus according to any one of the seventh to tenth aspects further includes an obstacle information obtaining section that obtains information about obstacles existing in proximity to the vehicle. The environment information obtaining section obtains the obstacle information detected by the obstacle information obtaining section as the environment information.

According to a twelfth aspect of the present invention, the controlling apparatus according to any one of the seventh to eleventh aspects further includes a road width storage section that stores therein road width information. The environment information obtaining section uses the road width information stored in the road width storage section as the environment information.

A vehicle according to a thirteenth aspect of the present invention includes: a plurality of steerable wheels, an actuator unit that drives to steer each of the steerable wheels independently, a wheel driving unit that drives to rotate each of the steerable wheels independently, and the controlling apparatus according to any one of the seventh to twelfth aspects of the present invention.

The controlling apparatus according to the first aspect of the present invention includes: a first operating section that operates the actuator unit so as to give at least one of the steerable wheels a steering angle; and a second operating section that operates the wheel driving unit so as to drive to rotate at least of the steerable wheels including the wheel to which the steering angle is given, and rotate at least one of the steerable wheels in a forward direction, and at least another of the steerable wheels in a reverse direction. Therefore, the vehicle can be advantageously moved by an angle that is at least larger than the maximum steerable angle of the wheels, by spinning each wheel driven to rotate against the road surface and combining the longitudinal vector component and the lateral vector component of a driving force generated by the wheels. Therefore, parallel parking can be achieved more easily, compared with a conventional vehicle whose movement is limited by the maximum steerable angle of the wheels.

In the controlling apparatus according to the second aspect of the present invention, the second operating section operates the wheel driving unit so that a sum of the lateral vector component of the driving force generated by at least two of the wheels that are driven to rotate by the wheel driving unit exceeds 0, and a sum of the longitudinal vector component thereof becomes 0. Therefore, in addition to the advantage of the first aspect of the present invention, a vehicle can be parallel-moved laterally by spinning each wheel against the road surface even if the steerable angle of its wheels is limited to an angle less than 90 degrees. Therefore, the driver can parallel park the vehicle easily even when a road width or a spacing in the front or back of the vehicle in the parking space is extremely limited.

If a vehicle can be parallel moved laterally as described above, even with the wheels with a steerable angle of less than 90 degrees (for example, 45 degrees), there are other advantages as described below, compared with a known vehicle having wheels that are steerable by 90 degrees.

The linking mechanism for steering wheels may be simplified. Therefore, weight can be reduced, and durability can be improved. In addition, because the electrical cabling or hydraulic piping can be simplified, interferences or repeated stresses can be avoided to improve reliability.

Moreover, it is not necessary to increase the operation amount of the known actuator. Therefore, the actuator can be prevented from increasing in size, as well as weight and parts cost thereof. Furthermore, a large space is not required for wheels to move upon being steered. Therefore, the vehicle can be prevented from increasing in size, and a space within the vehicle can be saved.

In the controlling apparatus according to the third aspect of the present invention, the steerable wheels include a front-right wheel, a front-left wheel, a rear-right wheel, and a rear-left wheel. The first operating section operates the actuator unit so as to give at least one of the front-right and front-left wheels and at least one of the rear-right and rear-left wheels a steering angle. The second operating section operates the wheel driving unit so that the lateral vector component of a driving force generated by the front-right and front-left wheels becomes the same in magnitude and direction as the lateral vector component of a driving force generated by the rear-right and rear-left wheels, and that the longitudinal vector component of a driving force generated by the front-right and front-left wheels becomes the same in magnitude but different in direction as the longitudinal vector component of a driving force generated by the rear-right and rear-left wheels. Consequently, the controlling apparatus allows the lateral vector component of the driving force to be applied equally to the front side (that is, the front wheels) and the rear side (that is, the rear wheels) of the vehicle. Therefore, in addition to the advantages according to the first or the second aspect of the present invention, it is possible to prevent the generation of a force that spins the vehicle in rotation, thereby achieving a stable parallel motion.

In the controlling apparatus according to the fourth aspect of the present invention, the steerable wheels include a front-right wheel, a front-left wheel, a rear-right wheel, and a rear-left wheel. The wheel driving unit is driven so that a lateral vector component of a driving force generated by one of either the front-right and front-left wheels or the rear-right and rear-left wheels becomes greater in magnitude in the same or a different direction than a lateral vector component of a driving force generated by the other of either the front-right and front-left wheels or the rear-right and rear-left wheels;

a longitudinal vector component of the driving force generated by one of either the front-right and front-left wheels or the rear-right and rear-left wheels becomes greater in magnitude in a different direction than a longitudinal vector component of a driving force generated by the other of either the front-right and front-left wheels or the rear-right and rear-left wheels; and

the lateral vector component of the driving force generated by the front-right wheel, the front-left wheel, the rear-right wheel, and the rear-left wheel to spin the vehicle in rotation is cancelled out by the longitudinal vector component of the driving force generated by the front-right wheel, the front-left wheel, the rear-right wheel, and the rear-left wheel. Therefore, in addition to the advantages according to the first or second aspect of the present invention, even if the lateral vector component of the driving force cannot be applied equally to the front side (that is, the front wheels) and the rear side (that is, the rear wheels) of the vehicle, it is still possible to advantageously cancel out the force to spin the vehicle in rotation, while maintaining the lateral vector component. Thus, a stable parallel motion is achieved.

In the controlling apparatus according to the fifth aspect of the present invention, the detecting section detects usage frequency of the steerable wheels, the determining section determines if the usage frequency detected by the detecting section exceeds a reference value, and the prohibiting section prohibits any wheel whose usage frequency is determined to exceed the reference value by the determining section from being driven in rotation. Therefore, the wheels are prevented from being used more frequently than the others, further preventing some wheels from wearing out sooner than the others. In other words, in addition to the advantages according to any one of the first to fourth aspects of the present invention, it is possible to control the wheels to be worn out equally, and to improve the life of the vehicle as a whole.

The vehicle according to the sixth aspect of the present invention includes the controlling apparatus according to any one of the first to fifth aspects of the present invention. Therefore, the vehicle has the same advantage as in any one of the first to fifth aspects of the present invention.

In the controlling apparatus according to the seventh aspect of the present invention, the turning pattern searching section searches a turning axis and a turning pattern for turning the vehicle based on the environment information obtained by the environment information obtaining section. The turn controlling section controls driving of the actuator unit to steer the wheels so that the vehicle is turned around the searched turning axis following the searched turning pattern.

In this manner, the turning axis and the turning pattern are searched appropriately depending on the surrounding environment of the vehicle, and each wheel is controlled so as to be steered independently to turn the vehicle based on the searched turning pattern around the searched axis. Therefore, even if the driver finds it difficult to make a turn by operating the steering wheel and the gas pedal because of the environment surrounding the vehicle, or even if there is only limited space for making a turn, the vehicle can be turned properly. Because the driver does not have to turn the steering wheel back and forth, the vehicle can advantageously make a turn safely and easily.

Because each wheel is controlled so as to be steered independently to turn the vehicle based on the turning pattern around the axis that are suitable for the surrounding environment, the wheels can be steered appropriately without requiring any burden to the driver. Therefore, the vehicle can advantageously be turned appropriately.

For example, FIGS. 25B, 26B, 27B and 28B show examples corresponding to FIGS. 25A, 26A, 27A and 28A where the driver cannot drive the vehicle 100 out of the parking lot by making a left turn in a forward direction around the turning axis A1, B1, or C1 with a minimum turning radius (5.8 meters) using the steering wheel and the gas pedal.

As shown in FIG. 25B, the vehicle 1 can be turned without scraping the wall 120a because the turn controlling section controls the steering and the rotation of each wheel by way of the actuators and the wheel driving unit so that the vehicle 1 is turned around the turning axis A2, which is detected by the turning pattern searching section based on the information about the environment around the vehicle 1.

In a similar manner, as shown in FIGS. 26B and 27B, the vehicle 1 can be turned without scraping the vehicle 130 parked in an adjacent parking space or the vehicle 140 parked in front of the vehicle 1, because the turn controlling section controls the steering and the rotation of each wheel by way of the actuator unit and the wheel driving unit so that the vehicle 1 is turned around the turning axes B2 and C2, respectively, which are detected by the turning pattern searching section based on the environment surrounding the vehicle 1.

FIG. 28B shows an example corresponding to FIG. 28A. In FIG. 28A, the driver is driving the vehicle 100 out from the parking lot to the roadway 160 by making a left turn in a forward direction around the turning axis D1 with a minimum turning radius (5.8 meters) using the steering wheel and the gas pedal, causing a dangerous situation because the vehicle 100 overruns the center line 180.

Because the turn controlling section controls the steering and the rotation of each wheel by way of the actuator unit and the wheel driving unit so that the vehicle 1 is turned around the turning axis D2, which is searched by the turning pattern searching section based on the environment surrounding the vehicle 1, the vehicle 1 can make a turn without overrunning the center line 180, as shown in FIG. 28B.

The environment information obtained by the environment information obtaining section includes vehicle position information obtained, for example, by the global positioning system (GPS); information about environment around the vehicle, such as the shape of the premise or the road width where the vehicle can be moved, obtained from the map data or parking lot information; and information about obstacles in proximity to the vehicle, captured by cameras or detected by sensors.

The turning pattern searching section for searching the turning axes or the turning patterns may employ, for example: a method that selects an available vehicle turning pattern from a memory that stores a plurality of turning patterns (data including the swept path of each wheel, widths in the lateral and longitudinal directions required to turn the vehicle) corresponding to a turning axis; or a method that searches an appropriate vehicle turning pattern from an infinite number of turning axes around the vehicle by simulation by computation.

In the controlling apparatus according to the eighth aspect of the present invention, the comparing section compares the turning patterns stored in the turning pattern storage section with the environment information obtained by the environment information obtaining section, and the turning pattern searching section searches a turning pattern from the turning pattern storage section based on the comparison result. Because an optimum turning pattern is selected from a predetermined number of the turning patterns, the vehicle can be advantageously turned with the optimum turning axis with a minimal control burden, in addition to the advantage of the controlling apparatus according to the seventh aspect of the present invention.

In the controlling apparatus according to the ninth aspect of the present invention, the driver-operated turnability determining section determines if the vehicle turnable under the environment information obtained by the environment information obtaining section by steering at least some of the wheels by an angle determined by a driver steering a steering wheel, and by applying a driving force determined by the driver operating a gas pedal to at least some of the wheels; and the search prohibiting section prohibits the turning pattern searching section from searching the turning axis and the turning pattern when the driver-operated turnability determining section determines that the vehicle is turnable by the driver operating the steering wheel and the gas pedal. Therefore, in addition to the advantages according to the seventh or eight aspect of the present invention, if the surrounding environment allows the driver to make a turn using the steering wheel and the gas pedal, the turning pattern searching section is advantageously prohibited from searching a turning axis or a turning pattern. As a result, the driver makes a turn by manually operating the steering wheel and the gas pedal.

Upon steering and rotating each wheel independently, the wheels often slip. Therefore, the wheels wear out more if each wheel is steered and rotated independently, compared with when the vehicle is turned by the driver operating the steering wheel and the gas pedal. Therefore, if the surrounding environment allows the driver to make a turn using the steering wheel and the gas pedal, the turn is made by the driver operating the steering wheel and the gas pedal. In this manner, the wheels can be advantageously suppressed from wearing out.

In the controlling apparatus according to the tenth aspect of the present invention, the premise-shape recognizing section recognizes the shape of an area surrounding the vehicle whose position information obtained by the vehicle position obtaining section, based on the map data stored in the map data storage section, and the movable area detecting section detects an area available for the vehicle to track based on the shape of the thus-recognized area, and the environment information obtaining section obtains the area detected by the movable area detecting section as the environment information. As a result, in addition to the advantages according to any one of the seventh to ninth aspects of the present invention, the turning pattern searching section can advantageously search a turning axis and a turning pattern using the area information detected by the movable area detecting section as the environment information.

Because it is possible to precisely recognize the shape of the premise surrounding the vehicle based on the map data using the obtained vehicle position information, the area available for the vehicle to track (movable area) can be also detected precisely. As a result, it is possible to advantageously search a tuning pattern that does not make the vehicle overrun the detected movable area.

The movable area (the area vehicle can be moved) detected by the movable area detecting section, may be equal to or smaller than the premise shape that is recognized by the premise-shape recognizing section.

For example, if the map data includes information such as shapes and positions of a building or a wall, the information about potential obstacles, such as the building or the wall, may be excluded from the premise shape, which is determined by premise-shape recognizing section, to obtain a movable area. If the map data includes information about a parking lot, the information about parking spaces in the lot, except for a space reserved for this vehicle, may be excluded from the movable area. If the premise-shape information, recognized by the premise-shape recognizing section, includes road information, the lanes legally prohibited from driving (in Japan, right lanes in the driving direction with respect to the center line) may be excluded from the movable area.

In the controlling apparatus according to the eleventh aspect of the present invention, the obstacle information obtaining section obtains information about obstacles in proximity to the vehicle, and the environment information obtaining section obtains the obstacle information detected by the obstacle information obtaining section as the environment information. As a result, in addition to the advantages according to any one of the seventh to tenth aspects of the present invention, the turning pattern searching section can search a turning axis and a turning pattern using the obstacle information detected by the obstacle information obtaining section as the environment information.

By obtaining the obstacle information, the turning pattern searching section can advantageously search the turning pattern in a precise manner to avoid the obstacles indicated by the obstacle information. As a result, the vehicle can be protected against a scrape or a collision.

The obstacle information obtaining section may employ: a method that obtains obstacle information based on images captured by cameras; a method that detects obstacles by a sensor or radar; and a method that obtains information about architectural structures, such as a building or a wall, from the map data and so on. If the obstacle information is obtained by images captured by the cameras, it is possible to obtain information not detectable by the sensor or radar (such as a boundary line of a parking space or a center line). If the obstacle information is obtained by the sensor or radar, it is possible to obtain information that is difficult to obtain from a static image (for example, information about other approaching vehicles on the road).

In the controlling apparatus according to the twelfth aspect of the present invention, the environment information obtaining section uses the road width information stored in a road width storage section as the environment information. As a result, in addition to the advantages according to any one of the seventh to eleventh aspects of the present invention, the turning pattern searching section can advantageously search a turning axis and a turning pattern using the road width information stored in the road width storage section as the environment information.

Because the turning pattern is selected based on the road width, it is advantageously possible to ensure selection of a turning pattern that prevents the vehicle from running off the road. Especially, if the road is a public roadway (road), the vehicle can be turned so that it does not run off the road width (width of the road itself or that of a one-way lane). Therefore, the vehicle can be reliably protected against scraping or colliding into other vehicles approaching from the opposite direction, ensuring safety.

The vehicle according to the thirteenth aspect of the present invention includes the controlling apparatus according to any one of the seventh to twelfth aspects of the present invention. Therefore, the vehicle has the same advantages as those of the controlling apparatus according to one of the seventh to twelfth aspects of the present invention.

### BRIEF DESCRIPTION OF THE DRAWINGS

FIG. 1 is a schematic drawing for showing a vehicle having a controlling apparatus according to a first embodiment of the present invention;

FIG. 2 is a block diagram for showing an electrical configuration of the controlling apparatus according to the first embodiment of the present invention;

FIGS. 3A to 3C are schematic drawings for showing information stored in the parallel-motion controlling table shown in FIG. 2;

FIG. 4 is a flowchart for showing a main process;

FIG. 5 is a flowchart for showing an updating process of a movement-direction memory;

FIG. 6 is a flowchart for showing a process of a parallel-motion control;

FIG. 7 is a flowchart for showing a process for storing a wheel-spin count;

FIGS. 8A to 8C are schematic drawings for showing information stored in a parallel-motion controlling table according to a second embodiment of the present invention;

FIGS. 8D to 8F are schematic drawings for showing information stored in a parallel-motion controlling table according to a third embodiment of the present invention;

FIGS. 9A to 9C are schematic drawings for showing information stored in a parallel-motion controlling table according to a fourth embodiment of the present invention;

FIGS. 9D to 9F are schematic drawings for showing information stored in a parallel-motion controlling table according to a fifth embodiment of the present invention;

FIGS. 9G to 9I are schematic drawings for showing information stored in a parallel-motion controlling table according to a sixth embodiment of the present invention;

FIGS. 10A and 10B are schematic drawings for showing information stored in a parallel-motion controlling table according to seventh and eighth embodiments, respectively, of the present invention;

FIGS. 11A and 11B are schematic diagram for explaining a ninth embodiment of the present invention;

FIGS. 11C and 11D are schematic drawings for showing information stored in a parallel-motion controlling table according to the ninth embodiment of the present invention;

FIGS. 12A to 12I are schematic drawings for showing variations of the information stored in the parallel-motion controlling table according to the ninth embodiment of the present invention;

FIGS. 13A to 13I are schematic drawings for showing alternative variations of the information stored in the parallel-motion controlling table according to the ninth embodiment of the present invention;

FIGS. 14A to 14C are schematic drawings for showing information stored in the parallel-motion controlling table according to a tenth embodiment of the present invention;

FIGS. 15A to 15 C are schematic top views showing a related-art technology of parallel parking a vehicle;

FIG. 16 is a schematic drawing for showing a vehicle provided with a controlling apparatus according to an eleventh embodiment of the present invention;

FIG. 17 is a block diagram for showing an electrical configuration of the controlling apparatus according to the eleventh embodiment of the present invention;

FIG. 18 is a schematic diagram for showing a structure of turn controlling tables;

FIG. 19 is a schematic drawing for explaining twenty representative turning axes selected for a front-left turn according to the eleventh embodiment of the present invention;

FIG. 20 is a schematic diagram for explaining a protruding length Ex in the x-direction and a protruding length Ey in the y-direction;

FIG. 21 is a bar graph for showing vehicle turning patterns corresponding to the twenty turning axes recorded in the front-left turn controlling table shown in FIG. 18;

FIG. 22 is a flowchart for showing a turning control process;

FIG. 23 is a flowchart for showing a surrounding environment recognizing process;

FIG. 24 is a flowchart for showing a turning control process according to a twelfth embodiment of the present invention;

FIG. 25A is a diagram for explaining an example of a problem upon making a turn with a conventional vehicle;

FIG. 25B is a diagram for explaining the effect of a vehicle and a controlling apparatus of the present invention;

FIG. 26A is a diagram for explaining an example of another problem upon making a turn with a conventional vehicle;

FIG. 26B is a diagram for explaining an advantageous effect of a vehicle and a controlling apparatus of the present invention;

FIG. 27A is a diagram for explaining an example of another problem upon making a turn with a conventional vehicle;

FIG. 27B is a diagram for explaining an advantageous effect of a vehicle and a controlling apparatus of the present invention;

FIG. 28A is a diagram for explaining an example of another problem upon making a turn with a conventional vehicle; and

FIG. 28B is a diagram for explaining an advantageous effect of a vehicle and a controlling apparatus of the present invention.

### DETAILED DESCRIPTION OF THE PREFERRED EMBODIMENTS

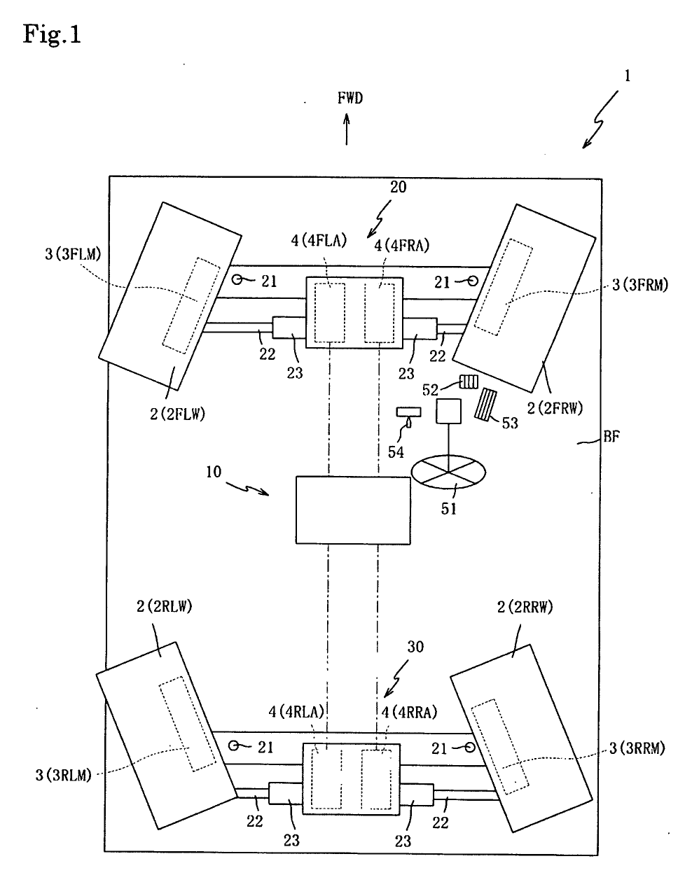

Exemplary embodiments of the present invention are explained herein with reference to the attached drawings. FIG. 1 is a schematic drawing for showing a vehicle 1 having a controlling apparatus 10 according to a first embodiment of the present invention. An arrow FWD in FIG. 1 indicates a forward direction of the vehicle 1. In FIG. 1, each wheel 2 is shown steered by a given angle.

To begin with, a general structure of the vehicle 1 is explained herein. As shown in FIG. 1, the vehicle 1 includes a body frame BF, the plurality of wheels 2 (four wheels in the first embodiment of the present invention) supported by the body frame BF, a wheel driving unit 3 that operates each wheel 2 in rotation independently, and an actuator unit 4 that operates to steer each wheel 2 independently.

Normally, the vehicle 1 can be moved in straight in a forward or backward direction (upward or downward directions in FIG. 1) by rotating all of the wheels 2 in the same direction, or the vehicle 1 can be turned by changing the steering angle of each wheel 2.

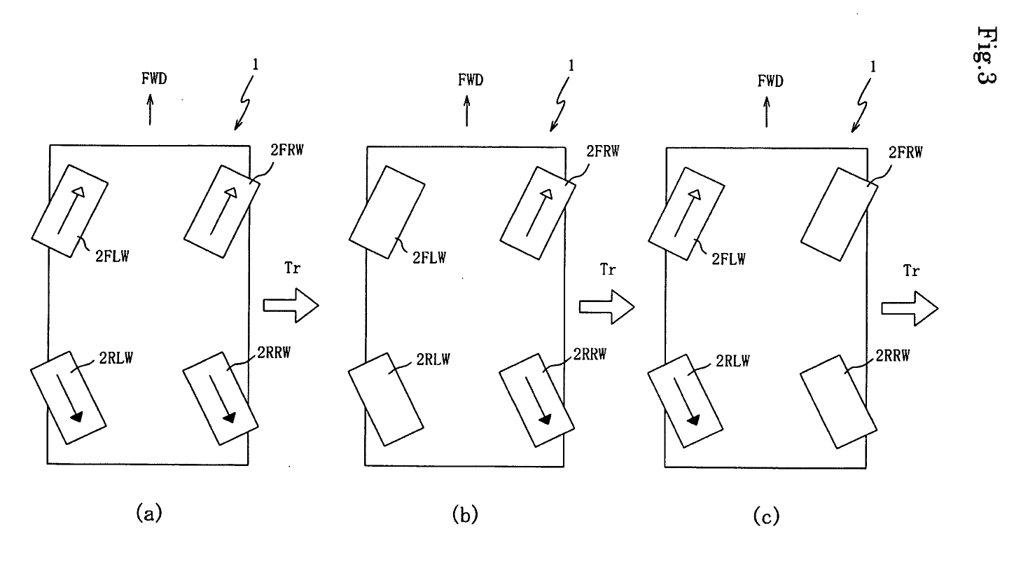

According to the present invention, the vehicle 1 can be also moved in parallel in the lateral directions (toward the right and left directions in FIG. 1) in a sliding manner with respect to the road surface. This movement is called “a parallel-motion”, which is to be described in details hereinafter. This movement is achieved by arranging each wheel 2 in a given position (hereinafter, “parallel-motion position”) and driving all or some of the wheels 2 in a rotating motion (see FIGS. 3A to 3C).

Each components included in the vehicle 1 is described in details herein. As shown in FIG. 1, the wheels 2 include four wheels: a front-left wheel 2FLW and a front-right wheel 2FRW located at the front side of the vehicle 1 with respect to the driving direction, and a rear-left wheel 2RLW and a rear-right wheel 2RRW located at the rear side of the vehicle 1 with respect to the driving direction. These wheels 2FLW to 2RRW can be steered by steering units 20, 30.

The steering units 20, 30 are provided to steer each of the wheels 2, and mainly include kingpins 21, tie rods 22, and articulating mechanisms 23, respectively, as shown in FIG. 1. Each of the kingpins 21 supports each wheel 2 so as to allow a pivoting movement thereof, and each of the tie rods 22 is linked to a knuckle arm (not shown) provided for each wheel 2. The articulating mechanism 23 is provided to articulate a driving force of the actuator 4 to the tie rod 22.

As described above, the actuator unit 4 is a driving/steering mechanism that operates to steer each wheel 2 independently. As shown in FIG. 1, the actuator unit 4 includes four actuators, 4FLA to 4RRA, respectively located at the front-right, front-left, rear-right, and rear left of the vehicle. When a driver turns a steering wheel 51, all or some (for example, only those for the front wheels 2FLW, 2FRW) of the actuators 4FRA to 4RLA are driven to steer the wheels 2 by an angle determined by a degree that a driver steers the steering wheel 51.

The operation of the actuator unit 4 is also triggered when the driver operates a parallel-motion switch 54. To prepare for the parallel-motion control, the actuator unit 4 positions each wheel 2 in its parallel-motion position by steering each wheel 2 by a given angle determined by operations of the parallel-motion switch 54 (see FIGS. 3A to 3C, for example). Details of the parallel-motion control are to be described hereinafter.

According to the first embodiment of the present invention, the front-left to rear-right actuators 4FLA to 4RRA are implemented as electrical motors, and the articulating mechanisms 23 are implemented as screws. When the electrical motor is rotated, the rotating movement thereof is converted into a liner movement by the articulating mechanism 23, and articulated to the tie rod 22. As a result, the wheel 2 is driven to pivot around the kingpin 21, and is steered by a given angle.

The wheel driving unit 3 is provided to rotate each wheel 2 independently. As shown in FIG. 1, the wheel driving unit 3 includes four electrical motors (front-left to rear-right motors, 3FLM to 3RRM, respectively), one for each wheel 2 (as an in-wheel motor). When the driver operates a gas pedal 53, each wheel driving unit 3 applies a driving force to each wheel 2, and the wheel 2 is rotated at a speed determined by how far the gas pedal 53 was stepped on by the driver.

The wheel driving unit 3 is also operated when a driver operates the parallel-motion switch 54. The parallel-motion control is performed by driving each wheel 2 in a rotating motion independently at a speed determined by operations of the parallel-motion switch 54 and the gas pedal 53 (see FIGS. 3A to 3C for example). Details of the parallel-motion control are to be described hereinafter.

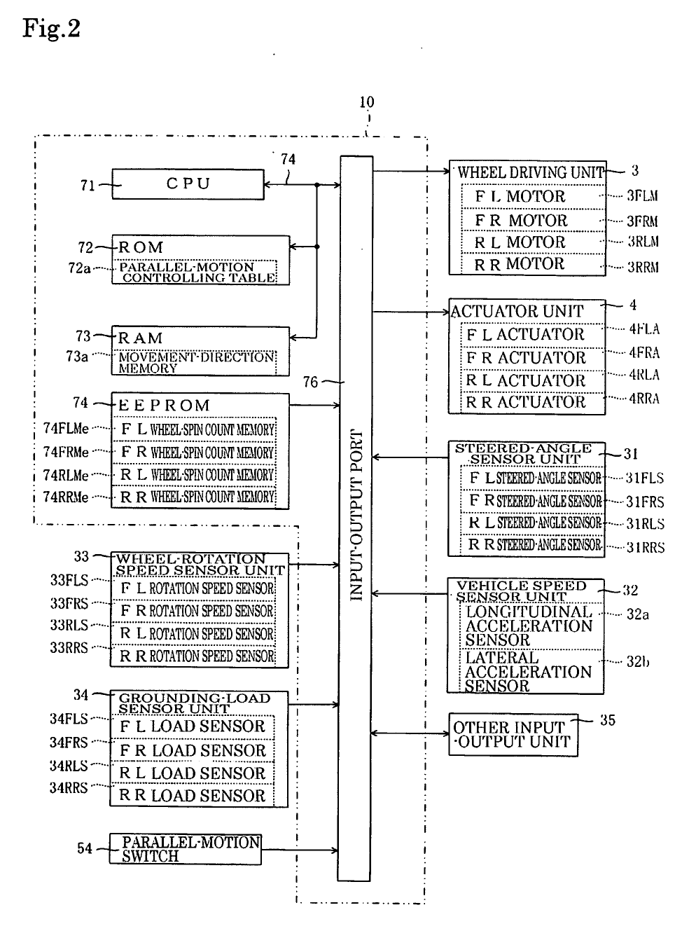

The controlling apparatus 10 is responsible for overall control of each structural element of the vehicle 1 described above. For example, the controlling apparatus 10 performs the parallel-motion control by controlling a steering angle and a rotation speed of each wheel 2 by way of the corresponding actuator 4 and wheel driving unit 3. Details about a structure of the controlling apparatus 10 are described herein with reference to FIG. 2.

FIG. 2 is a block diagram for showing an electrical configuration of the controlling apparatus 10. As shown in FIG. 2, the controlling apparatus 10 includes a CPU 71, a ROM 72, a RAM 73, and an EEPROM 74, each of which is connected to an input-output port 76 via a bus line 75. The units, such as the wheel driving unit 3, are connected to the input-output port 76.

The CPU 71 is a processor that controls each unit connected via the bus line 75. The ROM 72 is a non-writable, nonvolatile memory, and controlling programs executed by the CPU 71 or fixed value data, for example, are stored therein. The RAM 73 is a memory that stores various data in a writable fashion while the controlling programs are being executed. The EEPROM 74 is a writable, nonvolatile memory, and can store data persistently without a backup power supply, even after the controlling apparatus 10 is turned off.

As shown in FIG. 2, the ROM 72 includes a parallel-motion controlling table 72a. In the parallel-motion controlling table 72a, information used in the parallel-motion control is recorded, such as the parallel-motion position (steering position), a direction and a rate of rotation of each wheel 2. The parallel-motion controlling table 72a is explained in more details with reference to FIGS. 3A to 3C.

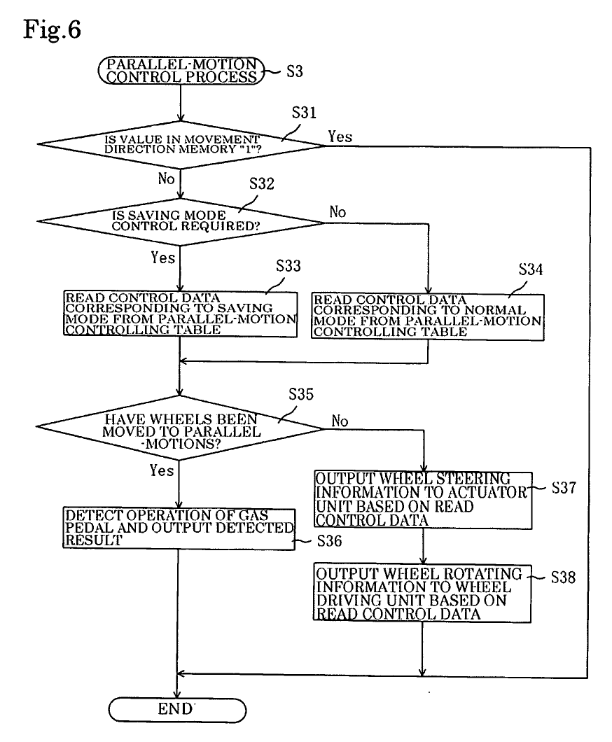

FIGS. 3A to 3C are schematic drawings for showing the information stored in the parallel-motion controlling table 72a. It should be noted that FIGS. 3A to 3C show only a part of the information stored in the parallel-motion controlling table 72a; that is, only the pattern information for moving the vehicle 1 to the right. In other words, the pattern information for moving the vehicle 1 to the left is omitted herein. The pattern shown in FIG. 3A corresponds to a normal mode (see step S33 in FIG. 6), and that shown in FIGS. 3B and 3C correspond to a saving mode (see step S34 in FIG. 6), respectively to be explained hereinafter.

Thickness of the arrows in FIGS. 3A to 3C indicates a relative rate at which each wheel 2 is rotated upon the parallel-motion control. In other words, a wheel with a thick arrow is rotated at a higher rate in relation to a rotation rate of a wheel with a thin arrow. An absolute value of the rotation rate is in proportion to a degree the gas pedal 53 is operated by the driver. In the patterns shown in FIGS. 3A to 3C, each arrow has the same thickness. This means that each wheel 2 is controlled to be rotated at the same speed.

A color of the arrows in FIGS. 3A to 3C indicates a direction in which each wheel 2 is rotated in the parallel-motion control. A white arrow indicates a rotation in the forward direction, and a black arrow indicates a rotation in the reverse direction. A wheel 2 without any arrow is not driven (prohibited from being driven) in rotation during the parallel-motion control.

Upon performing the parallel-motion control, the CPU 71 reads information corresponding to each wheel 2 from the parallel-motion controlling table 72a, such as the parallel-motion position, rotation direction, and rotation speed thereof. Based on the read information, the CPU 71 controls the actuator unit 4 and the wheel driving unit 3. By the actuator unit 4 and the wheel driving unit 3 being controlled, the wheels 2 are moved to their parallel-motion positions and rotated at a predetermined speed, and the vehicle 1 is parallel-moved in a lateral direction.

For example, FIG. 3A suggests that following information is recorded in the parallel-motion controlling table 72a as control data: steer the front wheels 2FLW, 2FRW toward right; steer the rear wheels 2RLW, 2RRW toward left; steer each wheel 2 by an angle of the same absolute value (steered by 45 degrees in the first embodiment of the present invention); rotate the front wheels 2FLW, 2FRW to forward; rotate the rear wheels 2RLW, 2RRW to reverse; and rotate each wheel 2 at the same rotation rate (speed).

When it is determined that the pattern of FIG. 3A is to be used for the parallel-motion control (see step S32 in FIG. 6), the CPU 71 reads the pattern (control data, such as a direction to steer the wheels 2, an absolute value for the steered angle, or a direction and a speed to rotate each wheel 2) from the parallel-motion controlling table 72a, and controls the actuator unit 4 and the wheel driving unit 3 based on the pattern (see steps S37 and S38 in FIG. 6).

By this control, the wheels 2 of the vehicle 1 are steered to the positions shown in FIG. 3A (their respective parallel-motion position). When a driver steps on the gas pedal 53, each wheel 2 is driven to rotate in the specified direction at a speed determined by a degree the gas pedal 53 is stepped on (see step S36 in FIG. 6).

In this manner, the wheels 2 spin on the road surface, because the vector component in the forward direction (upward direction in FIG. 3A) generated by the front wheels 2FLW, 2FRW is cancelled out by the vector component in the backward direction (downward direction in FIG. 3A) generated by the rear-right and rear-left wheels 2RLW, 2RRW. At the same time, the vector components toward right (the right direction in FIG. 3A) generated by the front wheels 2FLW, 2FRW and by the rear wheels 2RLW, 2RRW together function as a driving force to move the vehicle 1 to the right. As a result, the vehicle 1 is parallel-moved to the right (right direction in FIG. 3A).

FIG. 3B suggests that following information is stored in the parallel-motion controlling table 72a as control data: steer the front wheels 2FLW, 2FRW toward right; steer the rear wheels 2RLW, 2RRW toward left; steer each wheel 2 by an angle of the same absolute value (steered by 45 degrees in the first embodiment of the present invention); rotate the front-right wheel 2FRW to forward; rotate the rear-right wheel 2RRW backward; rotate the right wheels 2FRW, 2RRW at the same rotation rates (speed); and prohibit the left wheels 2FLW, 2RLW from being rotated.

For example, if the parallel-motion control takes place using this pattern shown in FIG. 3B, the vector component in the forward direction (upward direction in FIG. 3B) generated by the front-right wheel 2FRW is cancelled out by the vector component in the backward direction (downward direction in FIG. 3B) generated by the rear-right wheel 2RRW. At the same time, the vector components toward the right (right direction in FIG. 3B) generated by the right wheels 2FRW, 2RRW together function as a driving force to drive the vehicle 1 to the right. As a result, the vehicle 1 is parallel-moved to the right (right direction in FIG. 3B).

FIG. 3C suggests that following information is stored in the parallel-motion controlling table 72a as control data: steer the front wheels 2FLW, 2FRW toward right; steer the rear wheels 2RLW, 2RRW toward left; steer each wheel 2 by an angle of the same absolute value (steered by 45 degrees in the first embodiment of the present invention); rotate the front-left wheel 2FLW to forward; rotate the rear-left wheel 2RLW to reverse; rotate the left wheels 2FLW, 2RLW at the same rotation rates (speed); and prohibit the right wheels 2FRW, 2RRW from being rotated.

For example, if the parallel-motion control takes place using this pattern shown in FIG. 3C, the vector component in the forward direction (upward direction in FIG. 3C) generated by the front-left wheel 2FLW is cancelled out by the vector component in the backward direction (downward direction in FIG. 3C) generated by the rear-left wheel 2RLW. At the same time, the vector components toward the right (right direction in FIG. 3C) generated by the front-left wheel 2FLW and by the rear-left wheel 2RLW together function as a driving force to drive the vehicle 1 to the right. As a result, the vehicle 1 is parallel-moved to the right (right direction in FIG. 3C).

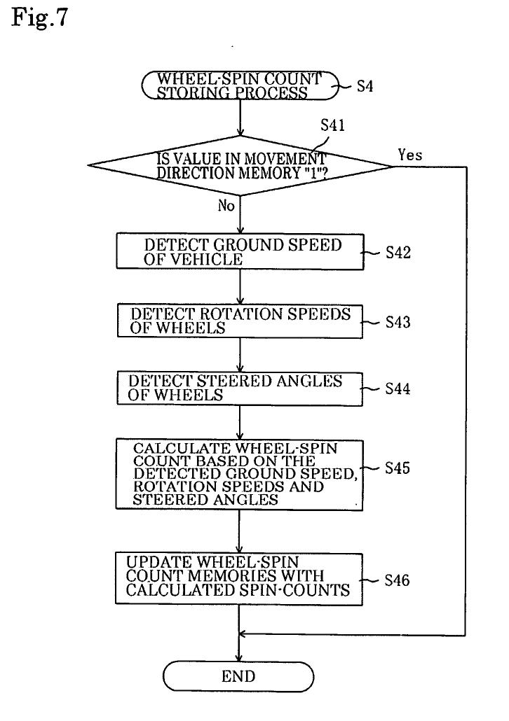

Explanation is continued referring back to FIG. 2. The RAM 73 has a movement-direction memory 73a as shown in FIG. 2. The movement-direction memory 73a maintains a value corresponding to a direction that the vehicle 1 is to be moved during the parallel-motion control. The movement-direction memory 73a is set to one of “0”, “1”, or “2” depending on operation of the parallel-motion switch 54 and a running condition (ground speed) of the vehicle 1 (see FIG. 7). The CPU 71 determines the direction to parallel-move the vehicle 1 based on the value stored in the movement-direction memory 73a.

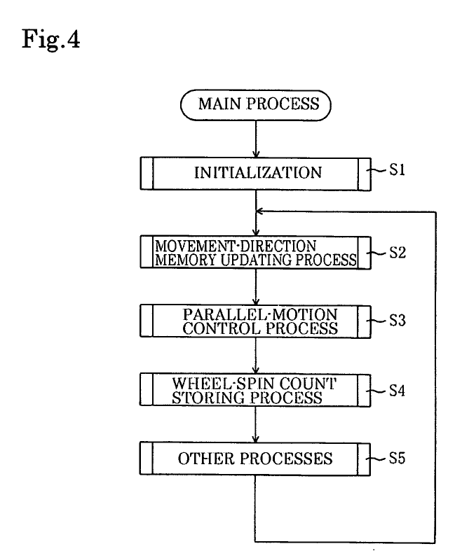

As shown in FIG. 2, the EEPROM 74 has a plurality of wheel-spin count memories 74FLMe to 74RRMe, each corresponding to each of the front-left, front-right, rear-left, and rear-right wheels 2FLW to 2RRW. The wheel-spin count memories 74FLMe to 74RRMe respectively records the number of times each wheel 2 (2FLW to 2RRW) is used. According to the first embodiment of the present invention, the wheel-spin count memories 74FRMe to 74RLMe accumulatively record the number of times each wheel 2 is spun against the road surface (see FIG. 4) as their usage frequency. Based on the counts stored, the CPU 71 decides whether to use the normal mode or the saving mode for the parallel-motion control (see step S3 in FIG. 6).

As described above, the wheel driving unit 3 is provided to drive each wheel 2 (see FIG. 1) in a rotating motion, and includes four motors 3FLM to 3RRM at the front-left, front-right, rear-left, and rear-right of the vehicle 1, and a driving circuit (not shown) that controls driving of each motor 3FLM to 3RRM based on an instruction from the CPU 71.

As also described above, the actuator unit 4 is provided to drive each wheel 2 to be steered, and includes four actuators 4FLA to 4RRA at the front-right, front-left, rear-right, and rear-left of the vehicle 1, and a driving circuit (not shown) that controls driving of each actuator 4FLA to 4RRA based on an instruction from the CPU 71.

A steered-angle sensor unit 31 is provided to detect a respective steered angle of each wheel 2, and to output the detected result to the CPU 71. The steered-angle sensor unit 31 includes four steered-angle sensors 31FLS to 31RRS for each wheel 2, and a processing circuit (not shown) for processing detection results of the steered-angle sensors 31FLS to 31RRS and outputting processed results to the CPU 71.

According to the first embodiment of the present invention, the respective steered-angle sensor 31FLS to 31RRS is provided in each articulating mechanism 23. The steered-angle sensor units 31 are implemented as non-contacting type rotation-angle sensors, which detects the number of rotations while a rotation is converted into a linear movement in the articulating mechanism 23. Because the rotation count is proportional to the displacement of the corresponding tie rod 22, the CPU 71 can obtain the steered angle of each wheel 2 based on the detected results (rotation counts) received from the steered-angle sensor units 31.

The steered-angle, detected by the steered-angle sensor unit 31, is an angle enclosed by a center line laid across the diameter of the wheel 2 and a reference line laid on a side of the vehicle 1 (the body frame BF), and determined regardless of the movement direction of the vehicle 1.

A vehicle speed sensor unit 32 is provided to detect the ground speed (an absolute value and a moving direction) of the vehicle 1 with respect to a road surface and to output the detected results to the CPU 71. The vehicle speed sensor unit 32 includes a longitudinal acceleration sensor 32a, a lateral acceleration sensor 32b, and a processing circuit (not shown) that processes the results detected by each acceleration sensor 32a, 32b and outputs the processed results to the CPU 71.

The longitudinal acceleration sensor 32a detects accelerated velocity of the vehicle 1 (the body frame BF) in the forward or backward direction (upward or downward direction in FIG. 1). The lateral acceleration sensor 32b detects accelerated velocity of the vehicle 1 (the body frame BF) in the right or left direction (right or left directions in FIG. 1). According to the first embodiment of the present invention, these acceleration sensors 32a, 32b are implemented as piezoelectric sensors using a piezoelectric element.

The CPU 71 can calculate a ground speed (an absolute value and a moving direction) of the vehicle 1 by respectively obtaining a time integration (an acceleration value) of each detection result of the acceleration sensors 32a, 32b received from the vehicle speed sensor unit 32, obtaining the velocity in each direction (longitudinal and lateral directions), and combining these two vector components.

A wheel-rotation speed sensor unit 33 is provided to detect a rotation speed of each wheel 2, and to output the detected results to the CPU 71. The wheel-rotation speed sensor unit 33 includes four rotation speed sensors 33FLS to 33RRS for each wheel 2, and a processing circuit (not shown) that processes the results detected by each of the rotation speed sensors 33FLS to 33RRS and outputs the processed results to the CPU 71.

According to the first embodiment of the present invention, the rotation speed sensor 33FLS to 33RRS is provided in the wheel 2, respectively, and detect an angular speed of each wheel 2 as a rotation speed. In other words, the rotation speed sensors 33FLS to 33RRS are implemented as an electromagnetic pickup sensor with a rotating body that rotates in cooperation with the wheel 2 and a pickup that electromagnetically detects the presence of a plurality of teeth provided on the circumference of the rotating body.

The CPU 71 can calculate a wheel-spin count (usage count) of each wheel 2 with respect to the road surface from following values: the rotation speed detected by the rotation speed sensors 33FLS to 33RRS received from the wheel-rotation speed sensor unit 33; an external diameter of each wheel 2; the steered-angle of each wheel 2 detected by the corresponding steered-angle detecting sensor unit 31; and the ground speed of the vehicle 1 calculated by the vehicle speed sensor unit 32.

A grounding load sensor unit 34 is provided to detect a grounding load generated between each wheel 2 and the road surface in contact therewith, and to output the detected results to the CPU 71. The grounding-load sensor unit 34 includes four load sensors 34FLS to 34RRS for each wheel 2, and a processing circuit (not shown) that processes the results detected by each of the load sensors 34FLS to 34RRS and outputting the processed results to the CPU 71.

According to the first embodiment of the present invention, the load sensors 34FLS to 34RRS are implemented as piezoresistive tri-axis load sensors. The load sensors 34FLS to 34RRS are provided on the suspension axis (not shown) of each wheel 2 to detect the grounding load in the longitudinal direction, the lateral direction, and the vertical direction.

The CPU 71 can detect a friction factor μ of the road surface at a point in contact with each wheel 2 from the detection result (grounding load) detected by each load sensor 34FLS to 34RRS and received from the grounding load sensor unit 34.

The front left wheel 2FLW is herein examined more closely as an example. If Fx is the load in the longitudinal direction, Fy is that in the lateral direction, and the Fz is that in the vertical direction respectively detected by the front-left sensor 34FLS, the friction factor μx in the traveling direction of the vehicle 1 can be calculated by Fx/Fz; and the friction factor μy in the lateral direction of the vehicle 1 can be calculated by Fy/Fz.

The parallel-motion switch 54 is provided so that the driver can instruct the controlling apparatus 10 to start or release the parallel-motion control, and to specify a direction to move the vehicle 1 using the parallel-motion control (all of which are not shown). The parallel-motion switch 54 includes an operating knob, a sensor, and a processing circuit. The operating knob allows the driver to select one out of three positions, “right”, “release”, and “left”, and is held at the selected position. The sensor detects the selected position of the operating knob. The processing circuit processes the result detected by the sensor and outputs the processed result to the CPU 71.

As described above, the CPU 71 sets one of the values “0”, “1”, and “2” to the movement-direction memory 73a according to the position of the parallel-motion switch 54 and the running condition (ground speed) of the vehicle 1 (see FIG. 7). Upon performing the parallel-motion control, the CPU 71 also determines the direction to parallel-move the vehicle 1 based on the value stored in the movement-direction memory 73a.

An example of other input-output unit 35 shown in FIG. 2 includes an operation condition detecting sensor unit (not shown) that detects the operation conditions of the steering wheel 51, a brake pedal 52, and the gas pedal 53 (for example, the rotated angle or stepped amount, or operation speed thereof) (see FIG. 1).

For example, when the gas pedal 53 is operated, the operation condition detecting sensor unit detects how far the gas pedal was operated, and outputs the detected degree to the CPU 71. The CPU 71, in turn, controls the wheel driving unit 3 according to the operated degree input from the operation condition detecting sensor unit to drive the wheels 2 in rotation.

A process executed by the controlling apparatus 10 is described herein with reference to FIGS. 4 to 7. FIG. 4 is a flowchart for showing a main process. The main process is repeatedly executed by the CPU 71 while the controlling apparatus 10 is powered on.

In the main process, initialization takes place after the power is turned on, such as to clear the RAM 73 to “0”, and to set the initial values thereto (step S1). However, in the initialization, the usage frequency data (a wheel-spin count) maintained in each wheel-spin-count memory 74FLMe to 74RRMe is exempted from being cleared.

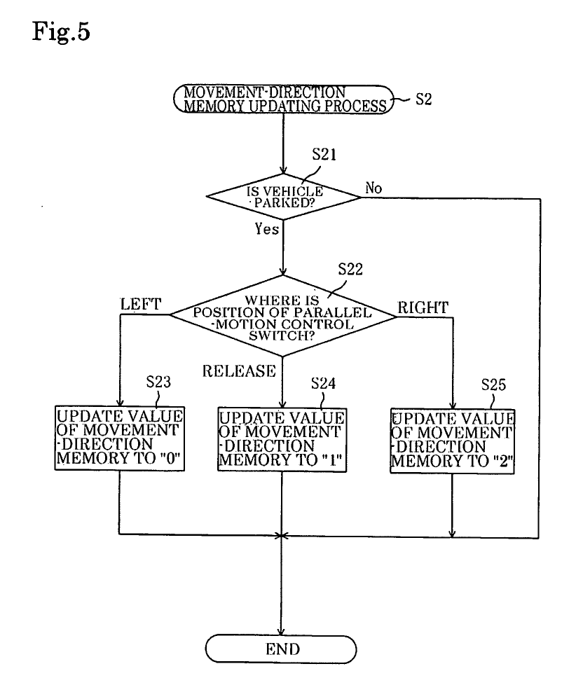

After initialization takes place at step S1, the movement-direction memory 73a is updated (step S2). It is explained herein how the movement-direction memory 73a is updated with reference to FIG. 5. FIG. 5 is a flowchart for showing an updating process of the movement-direction memory 73a.

Upon updating the moving direction (step S2), it is determined whether the vehicle 1 is parked (step S21) to determine if the vehicle 1 is in a condition that the parallel-motion control can be started, or to the direction of the parallel-motion can be changed.

If it is determined at step S21 that the vehicle 1 is parked (Yes at step S21), it means that the vehicle 1 is in the condition that the parallel-motion control can be started, or the direction of the parallel-motion can be changed. Therefore, if yes (Yes at step S21), the position of the parallel-motion switch 54 is detected (step S22), the movement-direction memory 73a is updated to one of “0”, “1”, or “2” (steps S23, S24, S25) according to the detected position of the parallel-motion switch 54, and the updating process of the movement-direction memory 73a (step S2) ends.

More specifically, if the parallel-motion switch 54 is at the “left” position (Left at step S22), the value maintained in the movement-direction memory 73a is updated to “0” (step S23). If the parallel-motion switch 54 is at the “release” position (Release at step S22), the value in the movement-direction memory 73a is updated to “1” (step S24). If the parallel-motion switch 54 is at the “right” position (Right at step S22), the value in the movement-direction memory 73a is updated to “2” (step S25).

In this manner, the CPU 71 can determine if the driver instructed to start the parallel-motion control to move the vehicle 1 either to the right or to the left, or to release (end) the parallel-motion control and drive normally (see FIG. 6).

If it is determined at step S21 that the vehicle 1 is not parked (No at step S21), it means that the vehicle 1 is now running, and it is not in the condition to start the parallel-motion control, or to change the direction of the parallel-motion. Therefore, if no (No at step S21), steps S22 to S25 are skipped even if the position of the parallel-motion switch 54 is changed by the driver. Thus, the movement-direction updating process (step S2) ends without updating the value in the movement-direction memory 73a.

In this manner, the movement-direction memory 73a is protected against being updated while the vehicle 1 is running, even if the driver operates the parallel-motion switch 54 carelessly. For example, the vehicle 1 is protected against being switched carelessly from a normal driving mode to the parallel-motion mode, or the direction of the parallel-motion being switched from one direction to the other while the vehicle 1 is parallel-moved.

Referring back to FIG. 4, the process executed by the controlling apparatus 10 is further explained. After updating the movement-direction memory 73a at step S2, the parallel-motion control is executed (step S3). A process of the parallel-motion control is explained herein with reference to FIG. 6. FIG. 6 is a flowchart for showing the process of the parallel-motion control.

Upon starting the parallel-motion control (step S3), it is determined if the movement-direction memory 73a is set to “1” (step S31). If it is determined that it is “1” (Yes at step S31), it means that parallel-motion switch 54 is set to its release position (see FIG. 5). Then, it is assumed that the driver has not operated the parallel-motion switch 54 yet, or a desired parallel-motion has been completed and the driver instructed to release (end) the parallel-motion control.

Therefore, if it is set to “1” (Yes at step S31), the parallel-motion control (step S3) ends without executing process of step S32 and thereafter, in other words, skipping the processes to parallel-move the vehicle 1 to a desired direction.

If, for example, the driver mistakenly operates the parallel-motion switch 54 carelessly to move the position thereof from the right to the release while the vehicle 1 is being parallel-moved toward the right, the movement-direction memory 73a is not updated from “2” to “1” until the vehicle 1 is parked (see FIG. 5). Therefore, the vehicle 1 can be prevented from stopping abruptly, even if the parallel-motion control (step S3) ends in the above condition (Yes at S31).

If it is determined that the movement-direction memory 73a is not set to “1” (No at step S31), it means that the parallel-motion switch 54 is set either to its left (“0”) or right (“1”) position (see FIG. 5). It is assumed that the operator has just given an instruction to parallel-move the vehicle 1 either to the left or right, or the parallel-motion control has been started and the vehicle 1 is being parallel-moved toward the left or the right. Therefore, when if the movement-direction memory 73a is not determined to be set to “1” (No at step S31), the subsequent process of step S32 and thereafter are executed to start or to continue the parallel-motion control.

Step S32 determines if the control in the saving mode is required (step S32). The CPU 71 reads the wheel-spin count of the wheels 2 from the front-left to rear-right wheel-spin count memories 74FLMe to 74RRMe, respectively, and compares each of the wheel-spin count to a reference value stored in advance in the ROM 72 to determine if there is any wheel 2 with spin count exceeding the reference value.

If there is no wheel 2 whose spin count exceeds the reference value, the CPU 71 determines that each of the wheels 2 are used (worn out) uniformly and it is not necessary to perform the parallel-motion control in the saving mode. Therefore, the CPU 71 selects the control in the normal mode (for example, using the pattern shown in FIG. 3A).

If there is at least one wheel 2 with spin count exceeding the reference value, the CPU 71 determines that each wheel 2 is used in different frequency (spun for different times). The CPU 71 then selects a saving mode (for example, using the pattern shown in FIG. 3B or 3C) to prohibit using the wheels 2 that are used at a high frequency so as to avoid further being worn out.

According to the first embodiment of the present invention, if there is more than one wheel 2 whose spin count exceeds the reference value, the wheel 2 with the highest spin count is prohibited from rotation. For example, if the spin count of the front-right wheel 2FRW is the highest, the parallel-motion of the vehicle 1 is controlled using the pattern shown in FIG. 3C so as to prohibit the rotation of the front-right wheel 2FRW upon parallel-moving the vehicle 1 in toward the right. If the front-left wheel 2FLW has the highest spin count, then the parallel-motion of the vehicle 1 is controlled using the pattern shown in FIG. 3B so as to prohibit the rotation of the front-left wheel 2FLW.

If it is determined that the control in the saving mode is required at step S32 (Yes at step S32), the CPU 71 reads the control data (the steering condition, the rotation direction and the rotated rate of each wheel 2) corresponding to the saving mode (the pattern shown in FIG. 3B or 3C, for example) from the parallel-motion controlling table 72a (step S33). If it is determined that the control in the saving mode is not required (No at step S32), the CPU 71 reads the control data corresponding to the normal mode (the pattern shown in FIG. 3A, for example) from the parallel-motion controlling table 72a.

At step S33 or S34, upon reading the control data from the parallel-motion controlling table 72a, the CPU 71 not only reads the control data corresponding to the mode selected at step S32, but also that corresponding to the value maintained in the movement-direction memory 73a and is read at step S31 (that is, the control data corresponding to the direction to parallel-move the vehicle 1, as specified by the driver).

After the necessary control data is read from the parallel-motion controlling table 72a at step S33 or S34, it is further determined if the wheels 2 have been moved to their parallel-motion positions (in other words, to parallel-move the vehicle 1 toward the right, the wheels 2 are to be moved to one of the positions shown in FIGS. 3A to 3C) (step S35).

If it is determined at step S35 that the wheels 2 have not been moved to their parallel-motion positions (No at step S35), it could be the first time to perform the parallel-control after the driver has instructed to start thereof. Therefore, the steering information of each wheel 2 (a steered direction, and an absolute value of the steered angle to which the wheel 2 is to be steered to reach its parallel-motion position) is output to the actuator unit 4 (step S37) based on the control data read at step S33 or S34. Subsequently, driving information of the wheels 2 (a rotation direction and a rotation rate) are output to each of the wheel driving units 3, respectively (step S38).

The actuator unit 4 steers the wheels 2, to their parallel-motion positions, respectively, based on the received steering information (for example, see FIGS. 3A to 3C). The wheel driving units 3 set the rotation direction and the rotation rate of the wheels 2, respectively, based on the received driving information to prepare for the gas pedal 53 to be stepped on (see step S36).

If it is determined at step S35 that the wheels 2 have already been moved to their parallel-motion position (Yes at step S35), it is considered that the parallel-motion of the vehicle 1 can be started or the vehicle 1 is currently being parallel-moved. Therefore, the operating condition of the gas pedal 53 is detected, and the detected result (operating condition) is output to the wheel driving units 3 (step S36). Subsequently, the parallel-motion control process (step S3) ends.

As described above, the rotation direction and the rotation rate have been set to the wheel driving unit 3 at step S38 based on the input control data. When the wheel driving unit 3 receives the operating condition of the gas pedal 53 is at step S36, the wheel driving units 3 drive the corresponding wheels 2 in rotation, based on the operating condition of the gas pedal 53 and the rotation direction and the rotation rate set at step S38. The vehicle 1 is parallel-moved thereby.

The CPU 71 detects the rotation speed of the wheels 2 via the wheel-rotation speed sensor units 33, and controls the wheel driving units 3 with a feed-forward control based on the detected results, so that the wheel driving units 3 drive each wheel 2 at the rotation rate set at step S38.

Referring back to FIG. 4, the process executed by the controlling apparatus 10 is further explained. After completion of the parallel-motion control process at step S3, a process for storing a wheel-spin count is executed (step S4). The process for storing the wheel-spin count is explained with reference to FIG. 7. FIG. 7 is a flowchart for showing the process for storing the wheel-spin count.

To store the wheel-spin count (step S4), it is at first determined if the value in the movement-direction memory 73a is “1” (step S41). If it is determined the value thereof is not “1” (No at step S41), it is assumed that the parallel-motion switch 54 is at its “left” position (“0”) or “right” position (“2”), that is, the vehicle 1 is in the process of parallel-motion. Therefore, processes at step S42 and thereafter are executed to detect the spin count of each wheel 2.

In other words, if it is determined the value thereof is not “1” (No at S41), a ground speed of the vehicle 1 is detected by the vehicle speed sensor units 32 (step S42), the rotation speed of each wheel 2 is detected by the wheel-rotation speed sensor unit 33 (step S43), and the steered angle of each wheel 2 is detected by the steered-angle sensor unit 31 (step S44). The spin count of each wheel 2 is calculated from the detected ground speed of the vehicle 1, the rotation speed and the steered angle of each wheel 2 (step S45). Values in the wheel-spin count memories 74FLMe to 74RRMe are updated based on the calculated spin count of each wheel 2 (step S46), and the wheel-spin count storing process (step S4) ends.

If it is determined the value in the movement-direction memory 73a is “1” at step S41 (Yes at step S41), it is assumed that the parallel-motion switch 54 is at the “release” position, the parallel-motion control of the vehicle 1 is not being performed. In other words, it is considered that the vehicle 1 is running normally, or parked. Therefore, if the value in the movement-direction memory 73a is “1” (Yes at step S41), it is not necessary to detect the spin count of each wheel 2. Therefore, step S42 and thereafter are skipped and the wheel-spin count storing process (step S4) ends.

According to the first embodiment of the present invention, the spin count of each wheel 2 is detected only when the parallel-motion control of the vehicle 1 is being performed; however, the detection of the wheel-spin count is without limitation, and it is also possible, obviously, to detect the spin count of each wheel 2 when the vehicle 1 is running normally. In other words, step S41 may also be omitted.

Referring back to FIG. 4, the process executed by the controlling apparatus 10 is further explained. After completing the wheel-spin count storing process at step S4, the system control executes other processes (step S5) and returns to step S2. The process of step S2 through step S5 is repeated while the controlling apparatus 10 is powered on.

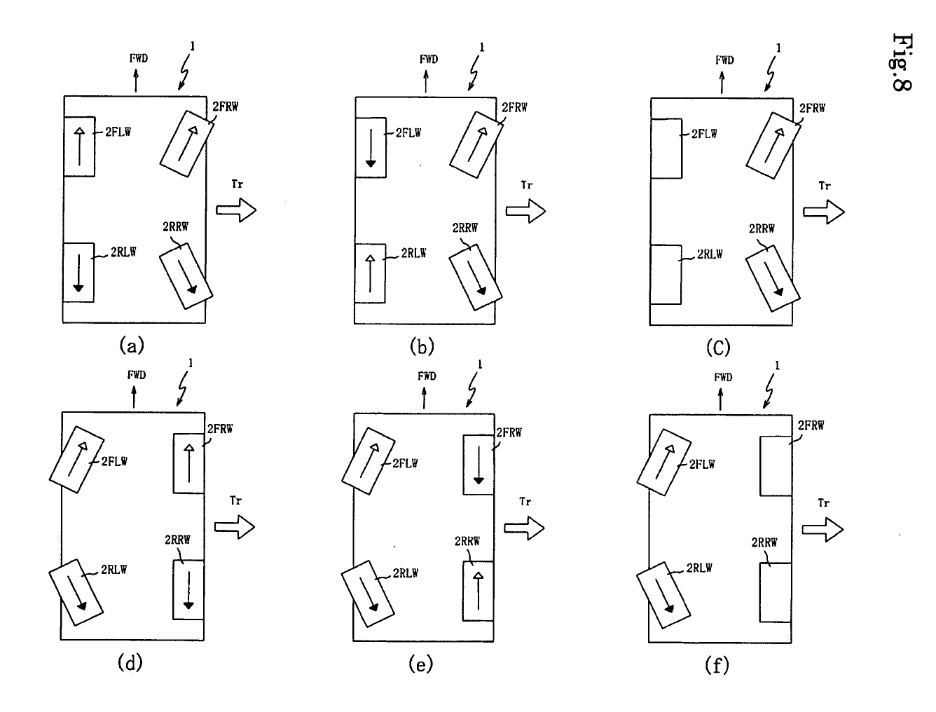

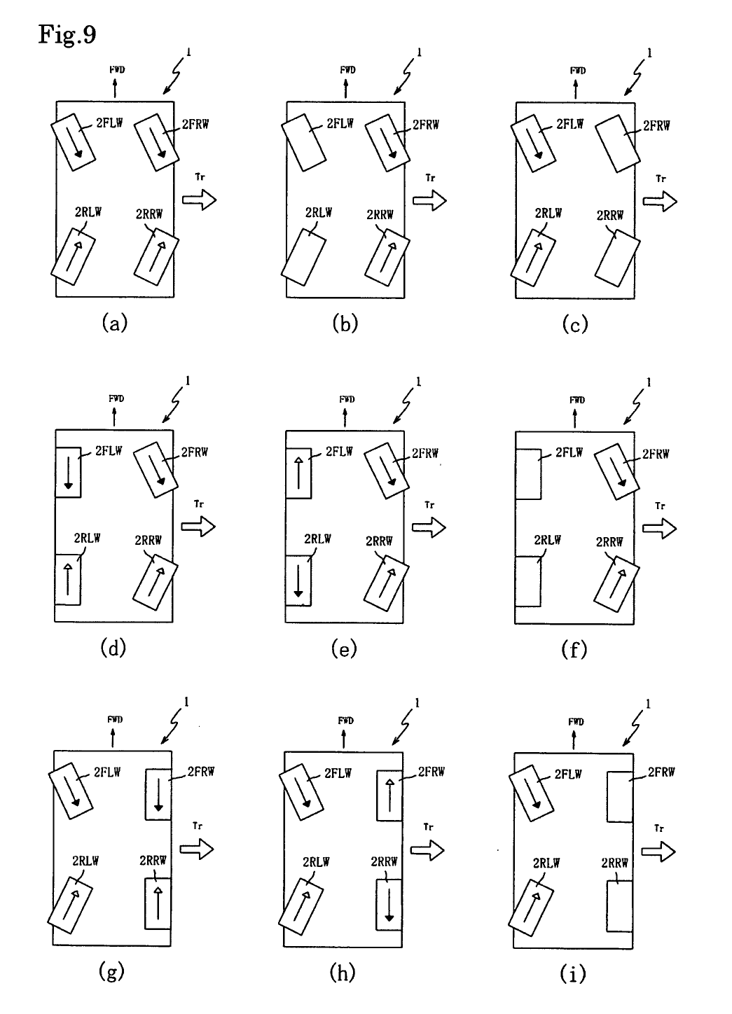

Second through sixth embodiments of the present invention are explained herein with reference to FIGS. 8A to 8C and FIGS. 9A to 9I. Those elements that are the same as in the first embodiment of the present invention are given the same reference numbers, and explanations thereof are omitted herein.

FIGS. 8A to 8C are schematic drawings for showing information stored in the parallel-motion controlling table 72a according to the second embodiment of the present invention. FIGS. 8D to 8F are schematic drawings for showing information stored in the parallel-motion controlling table 72a according to the third embodiment of the present invention. FIGS. 9A to 9C are schematic drawings for showing information stored in the parallel-motion controlling table 72a according to the fourth embodiment of the present invention. FIGS. 9D to 9F are schematic drawings for showing information stored in the parallel-motion controlling table 72a according to the fifth embodiment of the present invention. FIGS. 9G to 9I are schematic drawings for showing information stored in the parallel-motion controlling table 72a according to the sixth embodiment of the present invention.

FIGS. 8A to 8C and FIGS. 9A to 9I show only a part of the information stored in the parallel-motion controlling table 72a, that is, only patterns for moving the vehicle 1 to the right. In other words, data patterns for moving the vehicle 1 to the left are omitted herein.

Also, the arrows in FIGS. 8A to 8C and FIGS. 9A to 9I follow the same conventions defined for the first embodiment of the present invention. Therefore, the explanations thereof are omitted herein.

According to the second embodiment of the present invention, the right wheels 2FRW, 2RRW and the left wheels 2FLW, 2RLW are given steering angles of a different absolute value, in contrast to the first embodiment of the present invention, where all of the wheels 2 are steered by the angle of the same absolute value to be arranged at their parallel-motion positions (see FIGS. 3A to 3C).

For example, FIGS. 8A and 8B suggest that following information is stored as control data in the parallel-motion controlling table 72a according to the second embodiment of the present invention: to steer each of the right wheels 2FRW, 2RRW toward the opposing direction; steer the right wheels 2FRW, 2RRW by an angle of the same absolute value (steered by 45 degrees in the second embodiment of the present invention); steer the left wheels 2FLW, 2RLW by 0 degrees; rotate each of the right wheels 2FRW, 2RRW in the opposing direction; rotate the left wheels 2FLW, 2RLW in the opposing direction; and rotate each wheels 2 at the same rotation rate (speed).

When the parallel-motion control is executed, the actuator unit 4 steers the wheels 2 to their respective parallel-motion positions, and the wheel driving unit 3 drives the wheels 2 in rotation to spin each wheel 2 against the road surface based on the pattern described above.

As a result, the vector component in the forward direction (upward direction in FIGS. 8A and 8B) generated by the front wheels 2FLW, 2FRW is cancelled out by the vector component in the backward direction (downward direction in FIGS. 8A and 8B) generated by the rear wheels 2RLW, 2RRW. At the same time, the vector component to the right (right direction in FIGS. 8A and 8B) generated by the right wheels 2FRW, 2RRW functions as a driving force to drive the vehicle 1 to the right. As a result, the vehicle 1 is parallel-moved to the right (right direction in FIGS. 8A and 8B).

FIG. 8C suggests that following information is stored as control data in the parallel-motion controlling table 72a according to the second embodiment of the present invention: to steer each of the right wheels 2FRW, 2RRW toward the opposing directions; steer the right wheels 2FRW, 2RRW by an angle of the same absolute value (steered by 45 degrees in the second embodiment of the present invention); steer the left wheels 2FLW, 2RLW by 0 degrees; rotate each of the right wheels 2FRW, 2RRW in the opposing direction and at the same rotation rate (speed); and prohibit the left wheels 2FLW, 2RLW from being rotated.

When the parallel-motion control takes place using this pattern shown in FIG. 8C, the vector component in the forward direction (upward direction in FIG. 8C) generated by the front-right wheel 2FRW is cancelled out by the vector component in the backward direction (downward direction in FIG. 8C) generated by the rear-right wheel 2RRW. At the same time, the vector component toward the right (right direction in FIG. 8C) generated by the front-right wheel 2FRW and the vector component toward the right (right direction in FIG. 8C) generated by the rear-right wheel 2RRW together function as a driving force to drive the vehicle 1 to the right. As a result, the vehicle 1 is parallel-moved to the right (right direction in FIG. 8C).

According to the second embodiment of the present invention, the patterns shown in FIGS. 8A and 8B correspond to the normal mode, and the pattern shown in FIG. 8C corresponds to the saving mode.

As shown in FIGS. 8D to 8F, the patterns (information stored in the parallel-motion controlling table 72a) according to the third embodiment of the present invention are same as those according to the second embodiment except that the left wheels 2FLW, 2RLW are operated instead of the right wheels 2FRW, 2RRW.

When the parallel-motion control takes place using each pattern according to the third embodiment of the present invention, although detailed explanation thereof is omitted herein, the same effects as in those in the first and the second embodiments are achieved; therefore, the vehicle 1 can be moved in parallel. According to the third embodiment of the present invention, the patterns shown in FIGS. 8D and 8E correspond to the normal mode, and that shown in FIG. 8F corresponds to the saving mode.

As shown in FIGS. 9A to 9C, the patterns (information stored in the parallel-motion controlling table 72a) according to the fourth embodiment of the present invention are same as those according to the first embodiment (see FIG. 3A to 3C) except the each wheel 2 is steered to the opposite direction, and is rotated in the opposite direction.

When the parallel-motion control takes place using each pattern according to the fourth embodiment of the present invention, although detailed explanation thereof is omitted herein, the same effects as in those in the first to third embodiments are achieved; therefore, the vehicle 1 can be parallel-moved. According to the fourth embodiment of the present invention, the patterns shown in FIGS. 9A and 9B correspond to the normal mode, and that shown in FIG. 9C corresponds to the saving mode.

As shown in FIGS. 9D to 9F, the patterns (information stored in the parallel-motion controlling table 72a) according to the fifth embodiment of the present invention are same as those according to the second embodiment (see FIGS. 8A to 8B), except the right wheels 2FRW, 2RRW are steered to the opposite directions, and all of the wheels 2 are rotated in the opposite directions.

As shown in FIGS. 9G to 9I, the patterns (information stored in the parallel-motion controlling table 72a) according to the sixth embodiment of the present invention is same as that according to the third embodiment (see FIGS. 8D to 8F), except the left wheels 2FLW, 2RLW are steered to the opposite directions, and all of the wheels 2 are rotated in the opposite directions.

When the parallel-motion control takes place using each pattern according to the fifth and sixth embodiments of the present invention, although detailed explanation thereof is omitted herein, the same effects as in those in the first to fourth embodiments are achieved; therefore, the vehicle 1 can be parallel-moved.

According to the fifth embodiment of the present invention, the patterns shown in FIGS. 9D and 9E correspond to the normal mode, and that show in FIG. 9F corresponds to the saving mode. According to the sixth embodiment of the present invention, the patterns shown in FIGS. 9G and 9H correspond to the normal mode, and that show in FIG. 9I corresponds to the saving mode.

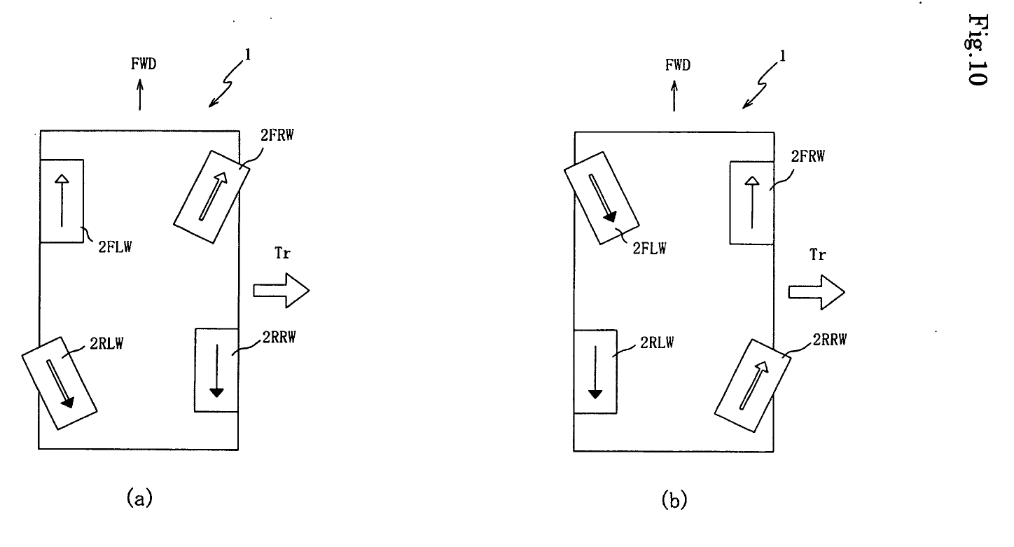

Seventh and eighth embodiments of the present invention are explained herein with reference to FIGS. 10A and 10B. These elements that are the same as the above embodiments of the present invention are given the same reference numbers, and explanations thereof are omitted herein. FIGS. 10A and 10B are schematic drawings for showing information stored in the parallel-motion controlling table 72a according to the seventh and eighth embodiments, respectively, of the present invention.

FIGS. 10A to 10B show only part of the information stored in the parallel-motion controlling table 72a, that is, the patterns for moving the vehicle 1 to the right, and illustration of the patterns for moving the vehicle 1 to the left is omitted herein. Also, the arrows in FIGS. 10A and 10B follow the same conventions defined for the first embodiment of the present invention. Therefore, the explanations thereof are omitted herein.

According to each embodiment explained above utilizes the patterns (information stored in the parallel-motion controlling table) having at least right wheels 2FRW, 2RRW steered by an angle of the same absolute value, and left wheels 2FLW, 2RLW steered by an angle of the same absolute value (see FIGS. 3A to 3C, FIGS. 8A to 8C, and FIGS. 9A to 9I). In the patterns according to the seventh and eight embodiment of the present invention, different absolute values are stored for the right wheels 2FRW, 2RRW, and also for the left wheels 2FLW, 2RLW.

For example, FIG. 10A suggests that following information is stored as control data in the parallel-motion controlling table 72a according to the seventh embodiment of the present invention: to steer the front-right wheel 2FRW and rear-left wheel 2RLW toward the opposing direction; steer the front-right wheel 2FRW and rear-left wheel 2RLW by an angle of the same absolute value (steered by 45 degrees in the seventh embodiment of the present invention); steer the front-left wheel 2FLW and rear-right wheel 2RRW by 0 degrees; rotate the front wheels 2FLW, 2FRW to forward; rotate the rear wheels 2RLW, 2RRW to reverse; rotate the front-right wheel 2FRW and rear-left wheel 2RLW at the same rotation rate (speed); rotate the front-left wheel 2FLW and rear-right wheel 2RRW at the same rotation rate (speed); and rotate the front-right wheel 2FRW and rear-left wheel 2RLW at the speed lower (or higher) than the front-left wheel 2FLW and rear-right wheel 2RRW.

When the parallel-motion control is executed, the actuator unit 4 steers the wheels 2 to their respective parallel-motion positions, and the wheel driving unit 3 drives the wheels 2 in rotation to spin each wheel 2 against the road surface based on the pattern described above.

As a result, the vector component in the forward direction (upward direction in FIG. 10A) generated by the front-left wheel 2FLW is cancelled out by the vector component in the backward direction (downward direction in FIG. 10A) generated by the rear-right wheel 2RRW. At the same time, the vector component in the forward direction (upward direction in FIG. 10A) generated by the front-right wheel 2FRW is cancelled out by the vector component in the backward direction (downward direction in FIG. 10A) generated by the rear-left wheel 2RLW. The vector component toward the right (right direction in FIG. 10A) generated by the front-right and rear-left wheels 2FRW, 2RLW function as a driving force to drive the vehicle 1 to the right. As a result, the vehicle 1 is parallel-moved to the right (right direction in FIG. 10A).

FIG. 10B suggests that following information is stored in the parallel-motion controlling table 72a according to the eighth embodiment of the present invention as control data: steer the front-left wheel 2FLW and rear-right wheel 2RRW toward the opposing direction; steer the front-left wheel 2FLW and rear-right wheel 2RRW by an angle of the same absolute value (steered by 45 degrees in the seventh embodiment of the present invention); steer the front-right wheel 2FRW and the rear-left wheel 2RLW by 0 degrees; rotate the right wheels 2FRW, 2RRW to forward; rotate the left wheels 2FLW, 2RLW to reverse; rotate the front-right wheel 2FRW and rear-left wheel 2RLW at the same rotation rate (speed); rotate the front-left wheel 2FLW and the rear-right wheel 2RRW at the same rotation rate (speed); and rotate the front-right wheel 2FRW and the rear-left wheel 2RLW at a speed higher (or lower) than the front-left wheel 2FLW and the rear-right wheel 2RRW.

When the parallel-motion control takes place using the pattern according to the eighth embodiment of the present invention, although detailed explanation thereof is omitted herein, the same effects as in that in the seventh embodiment are achieved; therefore, the vehicle 1 can be parallel-moved.

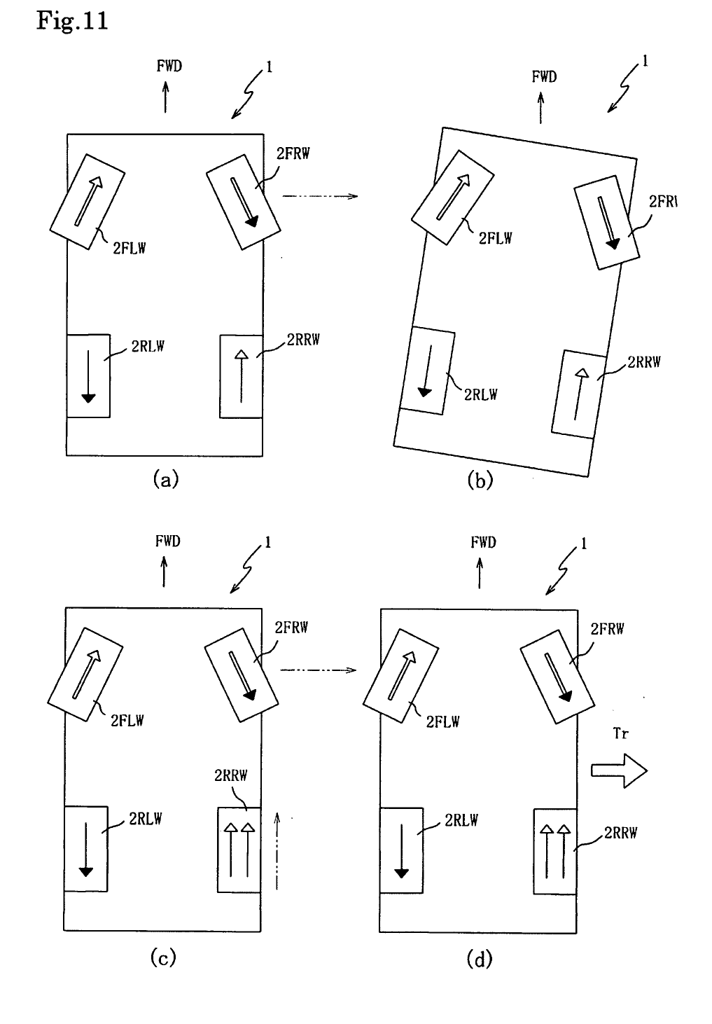

A ninth embodiment of the present invention is explained herein with reference to FIGS. 11A to 11D. These elements that are the same as the above embodiments of the present invention are given the same reference numbers, and explanations thereof are omitted herein. FIGS. 11A and 11B are schematic diagram for explaining the ninth embodiment of the present invention. FIGS. 11C and 11D are schematic drawings for showing information stored in the parallel-motion controlling table 72a according to the ninth embodiment of the present invention.

FIGS. 11C and 11D show only part of the information stored in the parallel-motion controlling table 72a, that is, the patterns for moving the vehicle 1 to the right, and illustration of the patterns for moving the vehicle 1 to the left is omitted herein. Also, the arrows in FIGS. 11C and 11D follow the same conventions defined for the first embodiment of the present invention. Therefore, the explanations thereof are omitted herein.

When the parallel-motion control takes place using the pattern shown in FIG. 11A, the front wheels 2FLW, 2FRW generate the force to move the vehicle 1 to the right. Therefore, the entire vehicle 1 is pushed to the right, with the front side thereof (that is, the vehicle side having the front wheels 2FLW, 2FRW) tilted. As a result, the entire vehicle 1 is moved to the right with clockwise rotation as shown in FIG. 11B.

In response to the above, according to the ninth embodiment of the present invention, the wheel driving units 3 are driven so as to cancel the rotating force caused by the lateral component of the driving force generated by the front wheels 2FLW to 2RRW, which attempts to rotate the entire vehicle 1, by the longitudinal component generated by the same wheels.

More specifically, according to the ninth embodiment of the present invention, the vehicle 1 is prevented from rotation by adopting the pattern shown in FIGS. 11C and 11D. In other words, FIG. 11C suggests that following information is stored as control data in the parallel-motion controlling table 72a according to the ninth embodiment of the present invention: to steer each of the front wheels 2FLW, 2FRW to the opposing direction (with a tendency of toe-in in the ninth embodiment of the present invention); steer the front wheels 2FLW, 2FRW by an angle of the same absolute value (steered by 45 degrees in the ninth embodiment of the present invention); steer the rear wheels 2RLW, 2RRW by 0 degrees; rotate the front-left and rear-right wheels 2FLW, 2RRW to forward; rotate the front-right and rear-left wheels 2FRW, 2RLW to reverse; rotate the front wheels 2FLW, 2FRW at the same rotation rate (speed); and rotate the rear-right wheel 2RRW at a speed higher than the rear-left wheel 2RLW.

When the parallel-motion control is executed, the actuator unit 4 steers the wheels 2 to their respective parallel-motion positions, and the wheel driving unit 3 drives the wheels 2 in rotation to spin each wheel 2 against the road surface based on the pattern described above.

As a result, the component to the right (right direction in FIG. 11A), which is generated by the front wheels 2FLW, 2FRW, acts on the vehicle 1 to be rotated to the right. Upon canceling the driving force of the front and rear wheels 2FLW to 2RRW in the longitudinal direction (upward/downward direction in FIG. 11A), there remains a driving force only in the rear-right wheel 2RRW to the forward direction of the vehicle 1 (upward direction in FIG. 11A). This remaining force at the rear-right wheel 2RRW functions to cancel the force to rotate the vehicle 1 to the right. In this manner, the vehicle 1 is parallel-moved to the right side of the vehicle 1 (right direction in FIG. 11D).

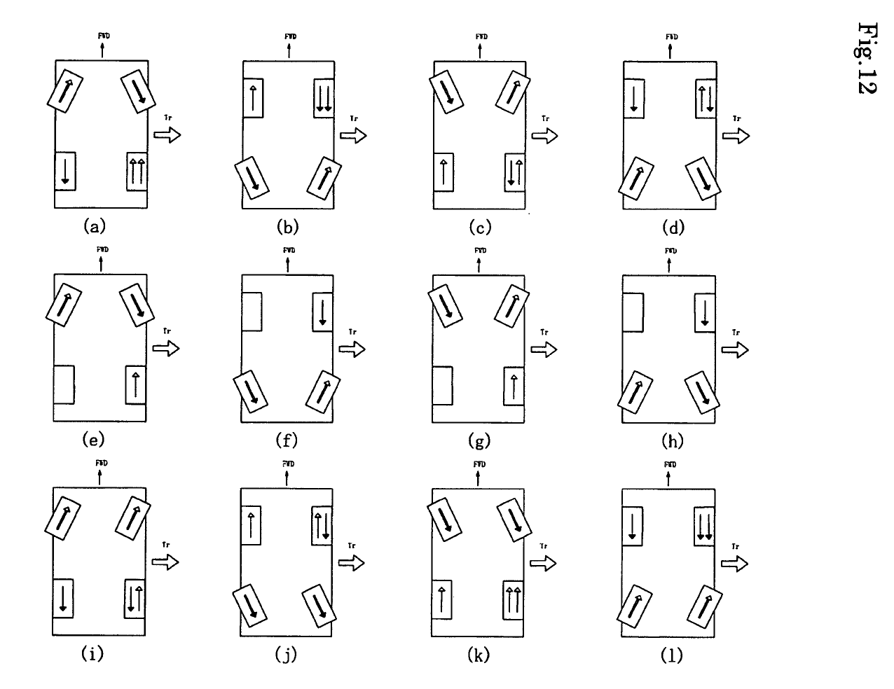

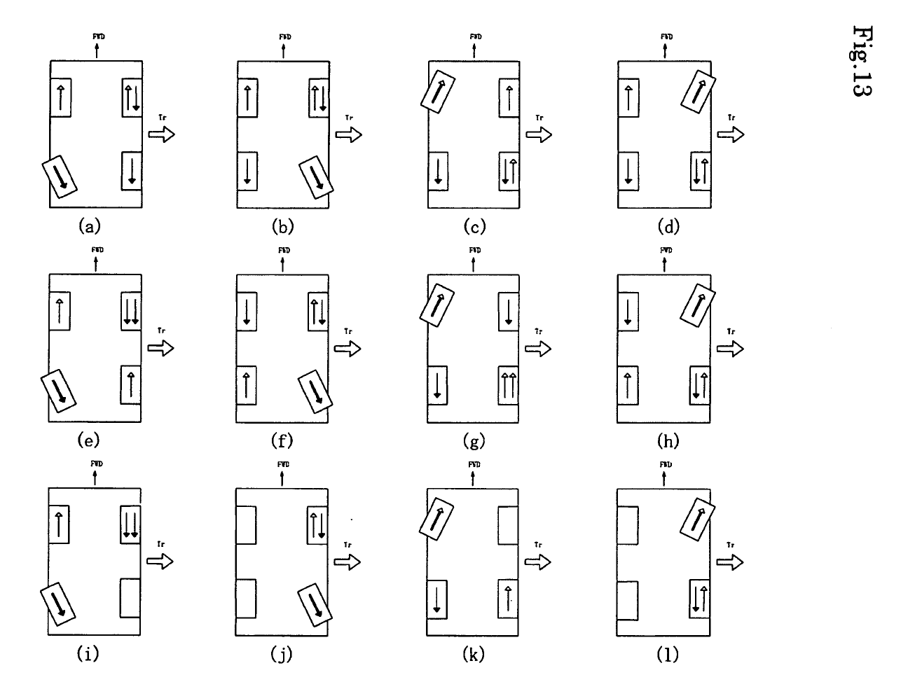

Variations of the ninth embodiment of the present invention are explained herein with reference to FIGS. 12A to 12I and FIGS. 13A to 13I. FIGS. 12A to 12I and FIGS. 13A to 13I are schematic drawings for showing information stored in the parallel-motion controlling table 72a, and show variations of the information stored in the parallel-motion controlling table 72a according to the ninth embodiment of the present invention.

FIG. 12A shows the information stored in the parallel-motion controlling table 72a according to the ninth embodiment of the present invention (same as FIG. 11C). FIGS. 12B to 12I and FIGS. 13A to 13I are variation thereof, having different parallel-motion positions (steered angles, rotation direction or rotation rate) of each wheel 2.

The elements that are the same as in the above embodiments are given the same reference numbers, and explanations thereof are omitted herein. In FIGS. 12A to 12I and FIGS. 13A to 13I, the reference numbers “2FLW to 2RRW”, showing the front and rear wheels, are omitted for easier understanding. The arrows in FIGS. 12A to 12I and FIGS. 13A to 13I follow the same conventions defined for the first embodiment of the present invention. Therefore, the explanations thereof are omitted herein.

By performing the parallel-motion control according to each pattern shown in FIGS. 12A to 12I and FIGS. 13A to 13I, the same effect as the ninth embodiment are achieved. In other words, when the vector component toward the lateral direction of the vehicle 1, generated by the wheels 2FLW to 2RRW attempts to rotate the entire vehicle 1, the rotating force thereof is cancelled by the vector components in the longitudinal direction generated by the wheels 2FLW to 2RRW. As a result, the vehicle 1 can be parallel-moved.

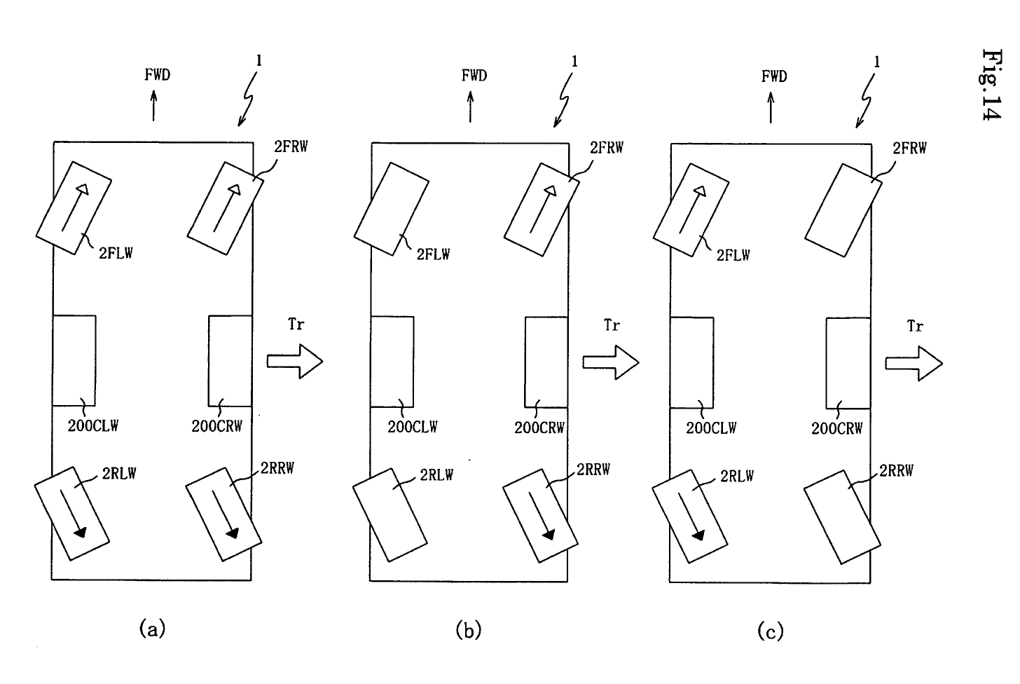

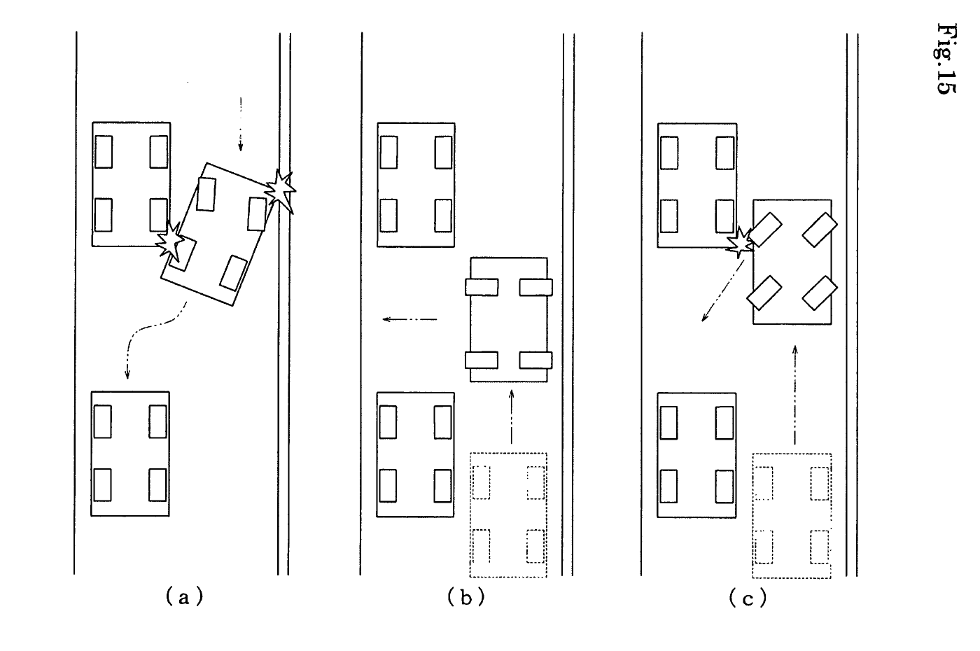

A tenth embodiment of the present invention is explained herein with reference to FIGS. 14A to 14C. FIGS. 14A to 14C are schematic drawings for showing information stored in the parallel-motion controlling table 72a according to the tenth embodiments of the present invention. The arrows in FIGS. 14A to 14C follow the same conventions defined for the first embodiment of the present invention. Therefore, the explanations thereof are omitted herein.

In the first embodiment of the present invention, the vehicle 1 includes four of the wheels 2 in total, including the front to rear wheels 2FLW to 2RRW. On the contrary, a vehicle 1 according to the tenth embodiment includes six wheels in total. The elements that are the same as in the above embodiments of the present invention are given the same reference numbers, and explanations thereof are omitted herein.

As shown in FIGS. 14A to 14C, the vehicle 1 according to the tenth embodiment includes six wheels in total. The front-left wheel 2FLW and the front-right wheel 2FRW located at the front side of the vehicle 1 with respect to the driving direction; the rear-left wheel 2RLW and the rear-right wheel 2RRW located at the rear side of the vehicle 1 with respect to the driving direction; and intermediate wheels 200CLW and 200CRW located between the front wheels 2FLW, 2FRW and the rear wheels 2RLW, 2RRW, respectively.

The intermediate wheels 200CLW, 200CRW are driven in rotation by the wheel driving unit (not shown) in the same manner as for the wheels 2FLW to 2RRW, and are supported on the vehicle 1 via lifting/supporting mechanisms, which lift the intermediate wheels 200CLW, 200CRW upward and downward with respect to the vehicle 1 (in the vertical direction with respect to the paper surface on which FIGS. 14A to 14C are placed).

In other words, during a normal operation, the intermediate wheels 200CLW, 200CRW are lifted down by the lifting/supporting mechanisms so as to contact the road surface, and driven in rotation by the wheel driving unit 3. In this manner, the driving force of the vehicle 1 can be enhanced. For the operation under the parallel-motion control, the intermediate wheels 200CLW, 200CRW are lifted from the road surface by the lifting/supporting mechanisms. In this manner, a driving force required for the parallel-motion control and the size of the wheel driving unit 3 (see FIG. 1) can be reduced. The intermediate wheels 200CLW, 200CRW is also prevented from wearing out so as to extend the lifetime thereof.

The parallel-motion control according to the tenth embodiment is the same as that according to the first embodiment (see FIG. 3), except the intermediate wheels 200CLW, 200CRW are lifted up and down by the lifting/supporting mechanisms. Therefore, the explanation thereof is omitted herein.

In the flowchart (the parallel-motion control) shown in FIG. 6, the first operating section according to claim 1 corresponds to step S37; the second operating section according to claim 1 corresponds to steps S36 and S38; the detecting section according to claim 5 correspond to step S32; the determining section according to claim 5 corresponds to step S32; a prohibiting section according to claim 5 corresponds to step S33. In the flowchart (the wheel-spin count storing process) shown in FIG. 7, the detecting section according to claim 5 corresponds to steps S42, S43, S44, and S45.

The present invention is explained herein with reference to the embodiment thereof; however, these embodiments are not intended to limit a scope of the present invention. It should be obvious for those skilled in the art that various improvements thereof are possible without deviating from the purpose of the present invention.

For example, the values indicated in the above embodiments are just examples; therefore, other values can also be used, naturally.

In the first to the ninth embodiment of the present invention, the vehicle 1 has four wheels 2 in total and, in the tenth embodiment, six wheels 2 in total. However, the numbers of wheels 2 are without limitation; therefore, the number of the wheels 2 may be three, five, or more than seven.

There is a phrase “the steerable wheels comprise a front-right wheel, a front-left wheel, a rear-right wheel, and a rear-left wheel” in claims 3 and 4. This phrase means that the wheels includes at least four of the wheels 2 (the front to rear wheels 2FLW to 2FRW), and is not intended to exclude those having five or more wheels 2. Therefore, the vehicle 1 having six wheels 2 (the front and rear wheels 2FLW to 2FRW, and intermediate wheels 200CLW, 200CRW), as described in the tenth embodiment of the present invention, is within the scope of claim 3 or claim 4.

According to the above embodiments of the present invention, the vehicle 1 is explained to be parallel-moved to the right; however, obviously, it is possible to move the vehicle 1 to the left based on the same technical concept described with reference to the above embodiments.

A unit for resetting the spin count memories 74FLMe to 74RRMe may be provided to reset (clear to 0) counts in the wheel-spin count memories 74FLMe to 74RRMe individually when a wheel 2 is replaced with a new one, although explanation thereof is omitted in the above embodiments. Also, it is also possible to provide a unit to correct (increment or decrement) counts in the wheel-spin count memories 74FLMe to 74RRMe. Also in the above embodiments of the present invention, the actuators 4 are implemented as electrical motors, and the articulating mechanisms 23 are implemented as threads; however, implementations thereof are without limitation. For example, the actuators 4 may be implemented as hydraulic or pneumatic cylinder. These implementations would allow the articulating mechanisms 23 to be removed, simplifying the structure, therefore, to reduce the weight and parts cost thereof.

Also, in the above embodiments of the present invention, explanation about a brake is omitted. However, it is obviously possible to provide a brake (such as a drum brake or a disk brake utilizing a frictional force) to some or all of the wheels 2. Furthermore, the wheel driving unit 3 may also function as a regenerative brake in replacement of, or in addition to such a brake.

Furthermore, in the explanation of the above embodiments, the vehicle 1 is moved in the lateral direction (for example, the right and left directions in FIG. 1). However, the parallel-motion control of the present invention is not limited to the lateral movement, and it is also obviously possible to parallel-move the vehicle 1 to other directions (such as the diagonal direction toward the front-right of the vehicle 1).

In other words, the parallel-motion control of the present invention is not limited to the movement of the vehicle 1 in the lateral directions, but also can be moved in any other directions. For example, a phrase “the vehicle is controlled to move in a direction toward an angle that is at least larger than the maximum steerable angle of the wheels” in claim 1 has the same intention. Therefore, the moving directions by such a control obviously include all other directions.

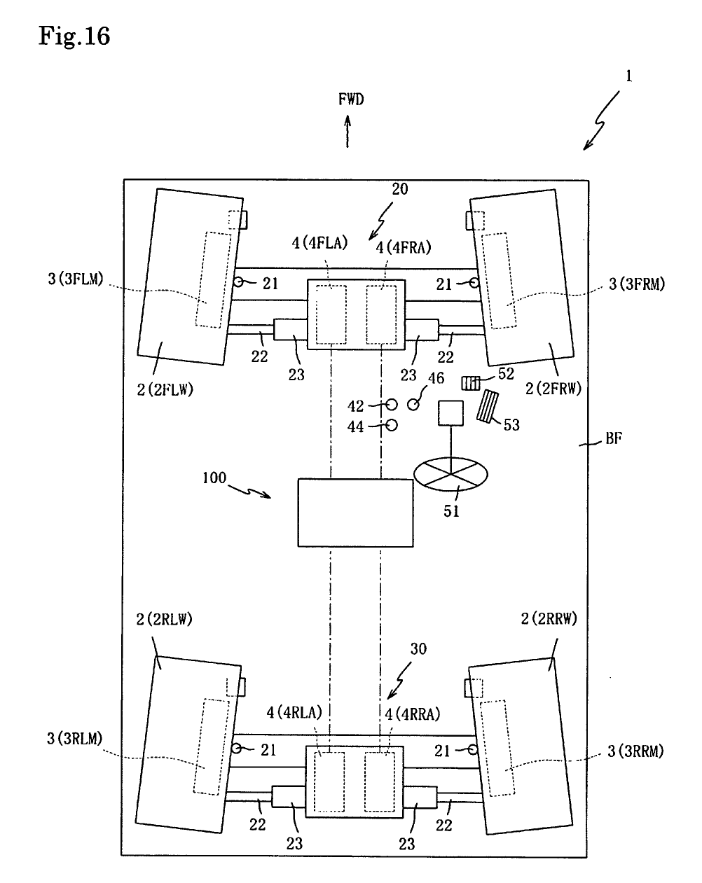

An eleventh embodiment of the present invention is explained herein with reference to FIGS. 16 to 22. According to the first to the tenth embodiments of the present invention, the controlling apparatus 10 of the vehicle 1 controls the steering and the rotation of the wheels 2, upon performing the parallel-motion control, by operating the wheel driving unit 3 and the actuator unit 4. Instead, a controlling apparatus 10 of the vehicle 1 according to the eleventh embodiment of the present invention, rotation of the vehicle 1 is controlled by the actuator unit 4 and the wheel driving unit 3 operating on the basis of a surrounding environment to control the steering and the rotation of the wheels 2.

FIG. 16 is a schematic drawing for showing a vehicle 1 provided with a controlling apparatus 100 according to the eleventh embodiment of the present invention. The arrow FWD in FIG. 16 indicates a forward direction of the vehicle 1. In FIG. 16, each wheel 2 is shown steered by a given angle.

To begin with, a general structure of the vehicle 1 is explained herein. As shown in FIG. 16, the vehicle 1 includes a body frame BF, a plurality of wheels 2 (four wheels in the eleventh embodiment of the present invention) supported by the body frame BF, a wheel driving unit 3 that drives each wheel 2 in rotation independently, and an actuator unit 4 that operates to steer each wheel 2 independently.

Each components included in the vehicle 1 is described in details. As shown in FIG. 16, the wheels 2 include four wheels: the front-left wheel 2FLW and the front-right wheel 2FRW located at the front side of the vehicle 1 with respect to the driving direction, and the rear-left wheel 2RLW and the rear-right wheel 2RRW located at the rear side of the vehicle 1 with respect to the driving direction. These wheels 2FlW to 2RRW can be steered by steering units 20, 30.

The steering units 20, 30 are provided to steer each of the wheels 2, and mainly include kingpins 21, tie rods 22, and articulating mechanisms 23, respectively, as shown in FIG. 16. Each of the kingpins 21 supports each wheel 2 allowing a pivoting movement thereof, and each of the tie rod 22 is linked to a knuckle arm (not shown) of each wheel 2. Each of the articulating mechanisms 23 is provided to articulate a driving force of the actuator 4 to the tie rod 22, respectively.

As described above, the actuator unit 4 is a driving/steering mechanism to steer and drive each wheel 2 independently. As shown in FIG. 16, the actuator unit 4 includes four actuators, 4FLA to 4RRA, at the front-left, front-right, rear-left, and rear-right of the vehicle, respectively. When a driver turns a steering wheel 51, all or some (for example, only those for front wheels 2FLW, 2FRW) of the actuators 4FLA to 4RRA are driven to steer the wheels 2 by an angle determined by amount the steering wheel 51 is steered.

Even when the driver does not turn the steering wheel 51, the actuators 4FRA to 4RLA are driven to steer the wheels 2 to a lateral direction depending on the environment surrounding the vehicle 1, when a turning control process is triggered. The turning control process, which is to be described in details hereinafter, is triggered when the driver pushes down (turns on) a small-turn switch 46. The turning control process allows the vehicle 1 to make a small-turn in the environment surrounding thereof. The corresponding actuators 4 (the front-left to the rear-right actuators 4FLA to 4RRA) are also driven as required to improve the braking force or the driving force.

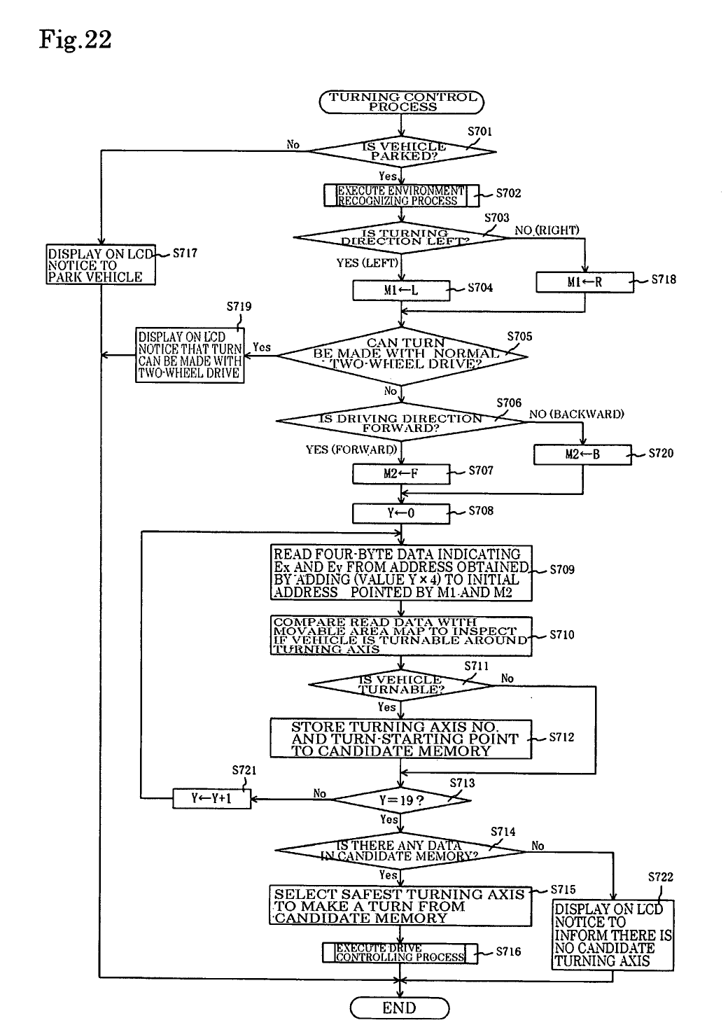

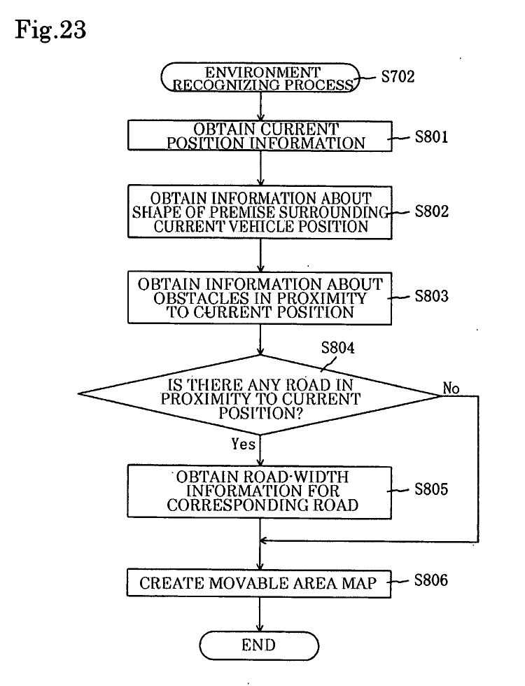

In other words, the actuator unit 4 operates to steer the wheels 2 for two purposes: to turn the vehicle 1, and to improve the braking force or the driving force. In the eleventh embodiment of the present invention, the former is referred to as a turning control, and the latter is referred to as a steering control. As mentioned above, the turning control process takes place when the driver turns the steering wheel 51, or pushes down the small-turn switch 46. Details about the turning control, especially that is triggered by pressing of the small-turn switch 46, are to be explained hereinafter with reference to FIGS. 22 and 23.

According to the eleventh embodiment of the present invention, the front-left to rear-right actuators 4FLA to 4RRA are implemented as electrical motors, and the articulating mechanisms 23 are implemented as screws. When the electrical motor is rotated, the rotating movement thereof is converted into a liner movement by the articulating mechanism 23, and articulated to the tie rod 22. As a result, the wheel 2 is driven to pivot around the kingpin 21, and the wheel 2 is steered by a given angle.

The wheel driving unit 3 is provided to rotate each wheel 2 independently. As shown in FIG. 16, the wheel driving unit 3 includes four electrical motors (front-left to rear-right motors, 3FLM to 3RRM, respectively), one for each wheel 2 (that is, as in-wheel motors). When the driver operates a gas pedal 53, each wheel driving unit 3 applies a driving force to each wheel 2, and the wheel 2 is rotated at a speed determined by how far the gas pedal 53 was stepped on by the driver. When the driver steps on the gas pedal 53, the electrical motors (front-left to rear-right motors, 3FLM to 3RRM, respectively) are rotated in a forward or a reverse direction, which is selected by a forward-motion switch 42 or a backward-motion switch 44 (selected by the driver pushing the switches). If the forward-motion switch 42 is pressed, the vehicle 1 is moved forward; if the backward-motion switch 44 is pressed, the vehicle 1 is moved backward.

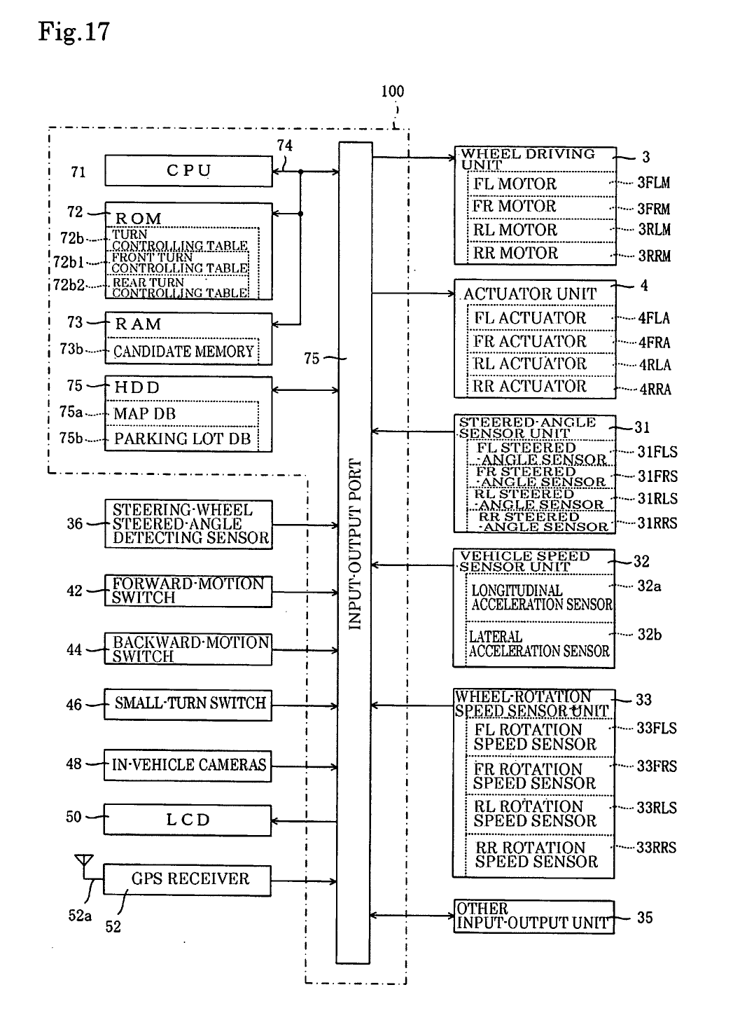

The controlling apparatus 100 controls each unit in the vehicle 1 having the structure described above. The controlling apparatus 100 controls to operate the wheel driving unit 3 when the gas pedal 53 is operated, and controls actuator unit 4 (performs turning control and steering control thereof) when the steering wheel 51, the brake pedal 52, or the gas pedal 53 is operated. The controlling apparatus 100 also performs the turning control and steering control, which is to be explained hereinafter, upon detection thereby of the small-turning switch 46 being pressed (see FIGS. 22 and 23). Details about a structure of the controlling apparatus 100 are described below with reference to FIG. 17.

FIG. 17 is a block diagram for showing an electrical configuration of the controlling apparatus 100. As shown in FIG. 17, the controlling apparatus 100 includes the CPU 71, the ROM 72, the RAM 73, and a hard disk 75 (hereinafter, “HDD 75”), each of which is connected to an input-output port 76 via a bus line 75. A plurality of units, such as the wheel driving unit 3, is connected to the input-output port 76.

The CPU 71 is a processor that controls each unit connected via the bus line 75. The ROM 72 is a non-writable, nonvolatile memory that stores therein, for example, controlling programs executed by the CPU 71 or fixed value data. The programs for executing the process shown in flowchart of FIGS. 22 and 23 are stored in the ROM 72.

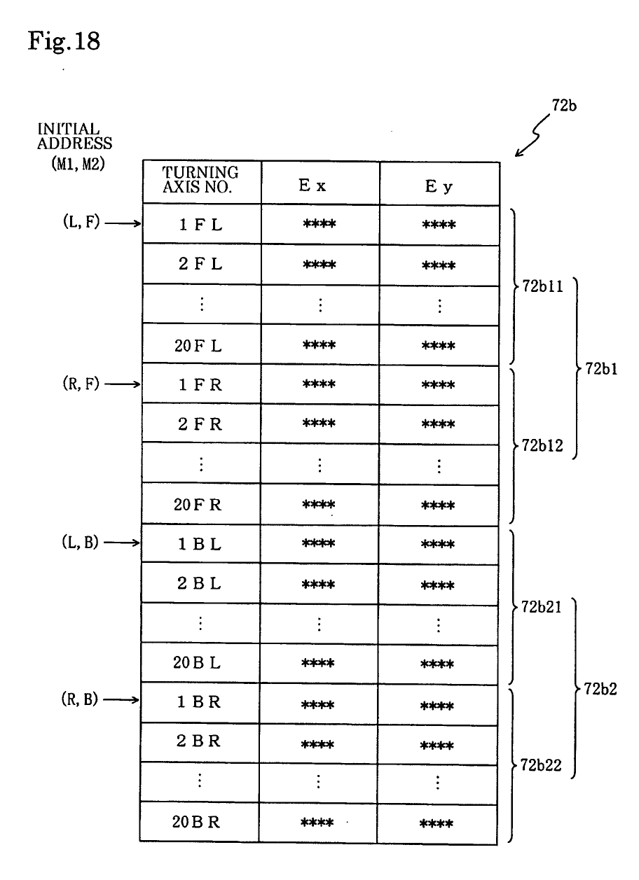

The ROM 72 also stores therein a plurality of turn controlling tables 72b. The turn controlling tables 72b stores vehicle turning patterns, including an x-direction protruding length Ex and a y-direction protruding length Ey corresponding to each axis to turn the vehicle 1. The turn controlling tables 72b include a front-turn controlling table 72b1 that stores the vehicle turning patterns used to make a front turn with the vehicle, and a rear-turn controlling table 72b2 that stores the vehicle turning patterns used to make a rear turn with the vehicle. Structures of the turn controlling tables 72b (the front-turn controlling table 72b1 and the rear-turn controlling table 72b2) are to be explained hereinafter with reference to FIG. 18.

The RAM 73 is a memory that stores various data in a writable fashion while the controlling programs are being executed, and includes a candidate memory 73b. When it is determined that one of the vehicle turning patterns, stored in the turn controlling tables 72b, to enable the vehicle 1 to make a turn as a result of a turning control process (see FIG. 22) to be explained hereinafter on the basis of the surrounding environment, the vehicle turning pattern is temporarily stored in the candidate memory 73 as a candidate. The candidate memory 73b is initialized (cleared) when the turning control process starts (see FIG. 22).

The HDD 75 is a writable, nonvolatile memory having a large storage capacity, and stores a map database 75a (hereinafter, “map DB 75a”) and a parking lot database 75b (hereinafter, “parking lot DB 75b”).

The map DB 75a is provided to accumulate map data. For example, the map data are read from a medium recorded with map data (such as a DVD) using a data reading apparatus (for example, a DVD apparatus) not shown, or received from an external information center via a communicating apparatus not shown as well.

The parking lot DB 75b is provided to accumulate parking lot data. The parking lot DB 75b stores data such as a shape of an entire parking lot, positions of the boundaries of parking space, a size thereof, or a width of an attached driveway.

As described above, the wheel controlling units 3 drives each wheel 2 (see FIG. 16) in a rotating motion, respectively, and includes four motors 3FLM to 3RRM at front-right, front-left, rear-right, and rear-left, and a driving circuit (not shown) that controls to drive each of the motors 3FLM to 3RRM based on an instruction from the CPU 71.

As also described above, the actuator unit 4 steers each wheel 2, and include four actuators 4FLA to 4RRA for each wheel, and a driving circuit (not shown) that controls to drive each of the actuators 4FLA to 4RRA based on instructions from CPU 71.

A steered-angle sensor unit 31 is provided to detect a steered angle of each wheel 2, and to output the detected result to the CPU 71. The steered-angle sensor unit 31 includes four steered-angle sensors 31FLS to 31RRS for each wheel 2, and a processing circuit (not shown) for processing detection results of the steered-angle sensors 31FLS to 31RRS and outputting processed results to the CPU 71.

The steered-angle, detected by the steered-angle sensor unit 31, is an angle enclosed by a center line laid across the diameter of the wheel 2 and a reference line laid on a side of the vehicle 1 (the body frame BF) (both lines not shown), and determined regardless of the direction in which the vehicle 1 moves to.

The vehicle speed sensor unit 32 is provided to detect the ground speed (absolute value and moving direction) of the vehicle 1 with respect to a road surface and to output the detected results to the CPU 71. The vehicle speed sensor unit 32 includes a longitudinal acceleration sensor 32a, a lateral acceleration sensor 32b, and a processing circuit (not shown) that process the results detected by each acceleration sensor 32a, 32b and outputs the processed results to the CPU 71.

The longitudinal acceleration sensor 32a detects accelerated velocity of the vehicle 1 (the body frame BF) in the forward and backward directions (upward and downward directions in FIG. 16). The lateral acceleration sensor 32a detects accelerated velocity of the vehicle 1 (the body frame BF) in the right and left directions (right and left directions in FIG. 16). The CPU 71 can calculate a ground speed (an absolute value and a moving direction) of the vehicle 1 by obtaining time integration (acceleration value) of each result detected by acceleration sensors 32a, 32b, respectively, to obtain the velocity in each direction (longitudinal and lateral directions), and combining these two vector components.

The wheel-rotation speed sensor unit 33 is provided to detect a rotation speed of the wheels 2, respectively, and to output the detected results to the CPU 71. The wheel-rotation speed sensor unit 33 includes four rotation speed sensors 33FLS to 33RRS for each wheel 2, and a processing circuit (not shown) that process the results detected by each rotation speed sensor 33FLS to 33RRS and outputs the processed results to the CPU 71. The CPU 71 can calculate actual circumferential velocity of each wheel 2 from the rotation speed of each wheel 2 received from the wheel-rotation speed sensor units 33, and external diameters of each wheel 2 stored in the ROM 72 in advance.

A steering-wheel steered-angle detecting sensor 36 detects a steered angle of the steering wheel 51. The steered angle of the steering wheel 51 can be obtained by inputting the detection result of the steering-wheel steered-angle detecting sensor 36 to the CPU 71.

The forward-motion switch 42 is pressed by the driver when he/she desires to move the vehicle 1 to forward. When the forward-motion switch 42 is pressed (turned on), the wheel driving units 3FLM to 3RRM, respectively located at the front-right, front-left, rear-right, and rear-left of the vehicle 1, are driven to forward. As a result, the vehicle 1 moves forward.

The backward-motion switch 44 is pressed by the driver when he/she desires to move the vehicle 1 to reverse. When the forward-motion switch 44 is pressed (turned on), the wheel driving units 3FRM to 3RLM, respectively located at the front-right, front-left, rear-right, and rear-left of the vehicle 1, are driven to reverse. As a result, the vehicle 1 moves backward. While the forward switch 42 is pressed (turned on), the backward switch 44 is always off. While the backward switch 44 is pressed (turned on), the forward switch 42 is always off. Both switches cannot be turned on simultaneously.

The small-turn switch 46 is pressed by the driver when he/she desires to activate the turning control (see FIG. 22), which is to be described hereinafter, to give the controlling apparatus 100 with an instruction to execute the turning control (see FIG. 22). The small-turn switch 46 turns off automatically when the turning control process (see FIG. 22) ends.

An in-vehicle camera 48 is a small CCD camera that can capture the image of an environment surrounding the vehicle 1. According to the eleventh embodiment of the present invention, the vehicle 1 is provided with four of the in-vehicle cameras 48, each located at the front, rear, right and left thereof to capture the image of the environment surrounding the vehicle 1 for 360 degrees. An LCD 50 is a liquid crystal display that displays various information or maps based on the map data.

A GPS receiver 52 receives position information (for example, latitude and longitude) of the vehicle 1 from a GPS satellite 400, not shown, via an antenna 52a. When position information is received from the GPS receiver 52, the CPU 71 calculates the current position of the vehicle 1 from the received position information, the ground speed detected by the vehicle speed sensor unit 32, and angular velocity of the vehicle 1 detected by a gyroscope, not shown.

The above-mentioned turn controlling tables 72b are explained herein with reference to FIG. 18. FIG. 18 is a schematic diagram for showing a structure of the turn controlling tables 72b. As shown in FIG. 18, the turn controlling tables 72b include the forward-turn controlling table 72b1 and the backward-turn controlling table 72b2.

The front-turn controlling table 72b1 stores data patterns to make a front turn with the vehicle 1, and further includes a front-left turn controlling table 72b11 and a front-right turn controlling table 72b12. The front-left turn controlling table 72b11 is used to make a front-left turn with the vehicle 1. The front-right turn controlling table 72b12 is used to make a front-right turn with the vehicle 1.

The rear-turn controlling table 72b2 stores patterns to make a rear turn with the vehicle 1, and further includes a rear-left turn controlling table 72b21 and a rear-right turn controlling table 72b22. The rear-left turn controlling table 72b21 is used to make a rear-left turn with the vehicle 1. The rear-right turn controlling table 72b22 is used to make a rear-right turn with the vehicle 1.

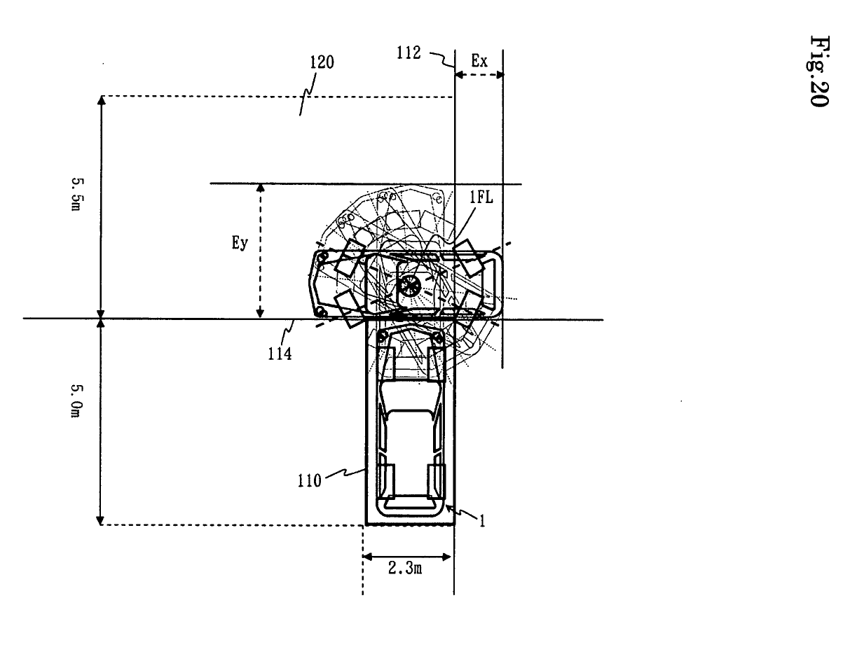

The front-left turn controlling table 72b11, the front-right turn controlling table 72b12, the rear-left turn controlling table 72b21, the rear-right turn controlling table 72b22 respectively store a x-direction protruding length Ex and a y-direction protruding length Ey of typical twenty axes to turn the vehicle 1, out of an infinite number of turning axes, as patterns to turn the vehicle 1. The x-direction protruding length Ex and the y-direction protruding length Ey are to be defined hereinafter with reference to FIG. 20.

The front-left turn controlling table 72b11, the front-right turn controlling table 72b12, the rear-left turn controlling table 72b21, the rear-right turn controlling table 72b22 are selected depending on values of the initial address specified upon reading the turn controlling tables 72b. Specifically, parameters M1 and M2 are set with values depending on the direction to turn (front-right turn, front-left turn, rear-right turn, rear-left turn) the vehicle 1 in the turning control process (see FIG. 22), which is to be explained hereinafter. As a result, the initial address for reading the turn controlling tables 72b is determined. For example, it is determined that the parameter M1 is set to “R” and the parameter M2 is set to “F” in the turning control process (see FIG. 22), the front-right turn controlling table 72b12 is selected.

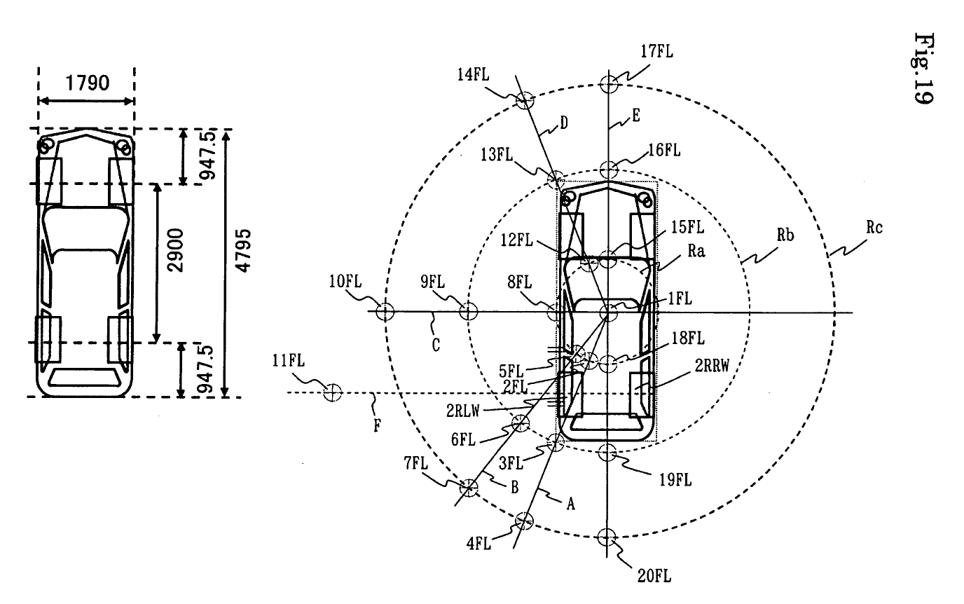

The turning axes recorded in the turn controlling table 72b is explained herein with reference to FIG. 19. FIG. 19 is a schematic drawing for explaining twenty representative turning axes selected for a front-left turn according to the eleventh embodiment of the present invention.

As shown in FIG. 19, three turning axes (No. 2FL to 4FL) are positioned on a line A connecting a center of a rectangle inscribing the vehicle 1 and a rear-left corner of the vehicle 1. Another three turning axes (No. 5FL to 7FL) are positioned on a line B connecting the center of the vehicle 1 and the front end of the rear-left wheel 2RL in the vehicle 1. Still another three turning axes (No. 8FL to 10FL) are positioned on a line C connecting the midpoints of two longer sides constituting the rectangle inscribing the vehicle 1. Still another three turning axes (No. 12FL to 14FL) are positioned on a line D connecting the center of the rectangle inscribing the vehicle 1 and a front-left corner of the vehicle 1. Still another seven turning axes (No. 1FL, 15FL to 20FL) are positioned on a line E connecting the midpoints of the two short sides of the rectangle inscribing the vehicle 1. A turning axis No. 1FL is positioned at the center of the rectangle inscribing the vehicle 1 (at the center of the vehicle 1). Another turning axis No. 11FL is positioned at a given point on a rotation axis F connecting the two rear wheels 2RR, 2RL of the vehicle 1, when these wheels are positioned in parallel, and have the same height.

The turning axes with No. 2FL, 5FL, 8FL, 12FL, 15FL, and 18FL are positioned at intersections between left-side circumference of a circle Ra and the lines A to E, respectively, where the radius of the circle Ra equals to the distance from the center of the vehicle 1 to a width of the vehicle 1. The turning axes with No. 3FL, 6FL, 9FL, 13FL, 16FL, and 19FL are positioned at intersections between left-side circumference of a circle Rb and the lines A to E, respectively, where the radius of the circle Rb is the diagonal distance from the center of the vehicle 1 to a corner of the rectangle inscribing the vehicle 1. The turning axes with No. 4FL, 7FL, 10FL, 14FL, 17FL, and 20FL are concentric to the circles Ra and Rb, and are positioned at intersections between left-side circumference of a circle Rc and the lines A to E, respectively, where the diameter of the circle Rc is greater than that of the circle Rb (for example, 1.5 times the diameter of the circle Ra).

By positioning the twenty turning axes around the vehicle 1 in the manner described above, vehicle turning patterns having twenty types of characteristics can be obtained. According to the eleventh embodiment of the present invention, the vehicle turning patterns are characterized by the x-direction protruding length Ex and the y-direction protruding length Ey.

The x-direction protruding length Ex and the y-direction protruding length Ey are herein explained with reference to FIG. 20. FIG. 20 is a schematic diagram for explaining the protruding length Ex and the protruding length Ey.

In FIG. 20, the vehicle 1 (4,795 millimeters in length×1,790 millimeters in width×1,770 millimeters in height) makes a turn from a parking space 110 (2.3 meters in width×5.0 meters in length) to a driveway 120 (5.5 meters in width) that is perpendicular to the parking space 110 around the turning axis No. 1FL.

The x-direction protruding length Ex is defined as a maximum distance that the vehicle 1 protrudes from a reference line 112 of x-direction upon making a turn. The x-direction reference line 112 is laid in parallel to the side of vehicle 1, parked at the initial position, being positioned opposite side to the turning direction. (According to the eleventh embodiment of the present invention, the x-direction reference line 112 is laid on a line extending over a longer side of the parking space 110.)

The y-direction protruding length Ey is defined as a maximum distance that the vehicle 1 protrudes from a reference line 114 in y-direction laid perpendicularly to the x-direction reference line 112. The turning axes are searched, in the turning control process (see FIG. 22) described later, by moving the y-direction reference line 114 toward the direction where the vehicle 1 is to move (forward or backward), from the front end of the vehicle 1 at the initial parked position.

Upon making a front-left turn, for example, the maximum x-direction protruding length Ex corresponds to the path swept by the rear-right corner of the vehicle 1, and the maximum y-direction protruding length Ey correspond to the path swept by the front-right corner of the vehicle 1. Assuming that turning axis is at a coordinates (X, Y); the length overall of the vehicle 1 is Lv; and the width overall of the vehicle 1 is Wv, then the distance DISTrr between the turning axis (X, Y) and the rear-right corner of the vehicle 1 can be obtained from an equation:

DISTrr=SQRT[({Wv/2}−X)²+({Lv/2}+Y)²]

The distance DISTrf between the turning axis (X, Y) and the front-right corner of the vehicle 1 can be obtained from an equation:

DISTrf=SQRT[({Wv/2}+X)²+({Lv/2}+Y)²]

The x-coordinate XrrN of the rear-right corner of the vehicle 1, upon making a left turn with an angle of N°, can be obtained from the equation:

XrrN=DISTrr×cos (θ+N°)−X=DISTrr(cos θ cos N°−sin θ sin N°)−X

where, cos θ=({Wv/2}−X)/DISTrr, and sin θ=({Lv/2}−Y)/DISTrr.

In the similar manner, the y-coordinate YrfN of the front-right corner of the vehicle 1, upon making a left turn by an angle of N°, can be obtained from the equation:

YrfN=DISTrf×sin (θ+N°)−Y=DISTrf(sin θ cos N°−cos θ sin N°)−Y

where, cos θ=({Wv/2}−X)/DISTrf, and sin θ=({Lv/2}-Y)/DISTrf.

The x-direction protruding length Ex upon making a left turn by an angle between 0° to N° will be the maximum value between XrrN(0°) and XrrN(N°). The y-direction protruding length Ey will be the maximum value between YrfN(0) and YrfN(N°).

Therefore, if the width of the area (e.g. a parking lot) to make a turn is Wp, then:

Ex=(Max {XrrN}−{Wp/2}) [Ex>0], Ex=0[Ex<0]; and

Ey=(Max {YrfN}+Y) [Ey>0], Ey=0[Ey<0].

By comparing an acceptable area (movable area), which varies depending on the space to make a turn, with the x-direction protruding length Ex and the y-direction protruding length Ey, the turning axis (X, Y) can be selected.

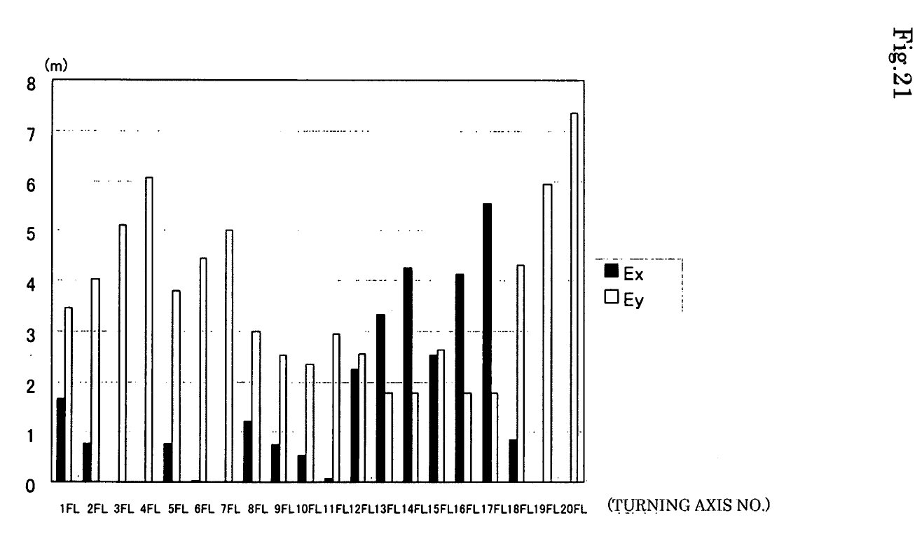

It is explained herein with reference to FIG. 21 the characteristics (that is, the x-direction protruding length Ex and the y-direction protruding length Ey) of each vehicle-turning pattern having one of the twenty axes with No. 1FL to 20FL selected for the vehicle 1 for making a front-right turn. FIG. 21 is a bar graph for showing the values (the x-direction protruding length Ex and the y-direction protruding length Ey) in the vehicle turning patterns, each corresponding each of the twenty turning axes with No. 1FL to 20FL, stored in the front-left turn controlling table 72b11. In the bar graph of FIG. 21, the turning axes with No. 1FL to 20FL are plotted in the horizontal axis, and values of the rotation patterns (the x-direction protruding length Ex and the y-direction protruding length Ey) are plotted in the vertical axis. According to the eleventh embodiment of the present invention, the front and rear overhangs of the vehicle 1 are to be equal. If the front and rear overhangs of the vehicle 1 are different, the turning axis can be changed so as to make these overhangs to be the same by giving a different steering angle, respectively.

As shown in FIG. 21, each turning axis has a characterizing vehicle-turning pattern (that is, the corresponding x-direction protruding length Ex and the y-direction protruding length Ey). For example, there is almost no x-direction protruding length Ex for the turning axes No. 3FL, 4FL, 7FL, 19FL, 20FL, meaning that the vehicle 1 can make a turn even if the right side thereof is in contact with a wall. The y-direction protruding length Ey for the turning axis No. 7FL is smaller than that for the turning axis No. 20FL. This means that, if space is limited in the moving direction (y-direction) of the vehicle 1, the turning axis No. 7FL should be used instead of the turning axis No. 20FL. The x-direction protruding length Ex for the turning axis No. 17FL is larger than the y-direction protruding length Ey thereof. This means that the turning axis No. 17FL is effective for making a turn when there is more space available in the direction (x-direction) perpendicular to the moving direction (y-direction) of the vehicle 1.

The turning control of the vehicle 1 according to the eleventh embodiment of the present invention is explained herein with reference to the flowcharts of FIG. 22 and FIG. 23. FIG. 22 is a flowchart for showing a turning control process executed by the CPU 71 in the vehicle 1.

The turning control is triggered by the operator pressing (turning on) the small-turn switch 46 and steering the steering wheel 51 to a desired turning direction (right turn or left turn) (by the steering-wheel steered-angle detecting sensor 36 detecting the rotation of the steering wheel 51). To begin with, it is determined if the vehicle 1 is parked (step S701).

If it is determined that the vehicle 1 is parked at step S701 (Yes at step S701), an environment recognizing process is executed (step S702). In the environment recognizing process, a movable area map is created. The movable area map shows an area where the vehicle 1 can be moved to, based on recognitions of the surrounding environment of the vehicle 1.

A process for recognizing the surrounding environment (step S702) is explained herein with reference to FIG. 23. As shown in FIG. 23, at the beginning of the environment recognizing process (step S702), current position information of the vehicle 1 is obtained from the position information (latitude and longitude) received from the GPS satellite 400 (not shown) using the GPS receiver 52 (step S801).

After completion of step S801, information about the shape of the area (shape of the premise) around the current position of the vehicle 1 is obtained from the map data stored in the map DB 75a and the parking lot data stored in the parking lot DB 75b (step S802).

At step S802, because the exact current position of the vehicle 1 is known from step S801, it is possible to obtain the information about the exact shape of the area surrounding the current position of the vehicle 1 from the data stored in the map DB 75a or the parking lot DB 75b. The movable area map is created based on the shape of the premise around the current position of the vehicle 1 in the manner to be explained hereinafter. Therefore, by obtaining exact information about the shape of the premise around the current position of the vehicle 1, the movable area map can be created accurately. As a result, a turning axis of the vehicle 1 can be accurately searched and selected to prevent the vehicle 1 from protruding from the movable area map. In this manner, the vehicle 1 is turned safely without causing a scrape or a collision.

Subsequently, information about the obstacles around the current position of vehicle 1 is obtained (step S802). The obstacle information can be obtained from the images captured by the in-vehicle cameras 48, the building or wall information included in the map data stored in the map DB 75a, and information about the parking space boundaries stored in the parking lot DB 75b.

If the obstacle information is obtained via the image captured by the in-vehicle cameras 48, it is possible to include information not detected by an object-detecting apparatus, such as a sensor or radar (such as a boundary line of the parking space or a center line).

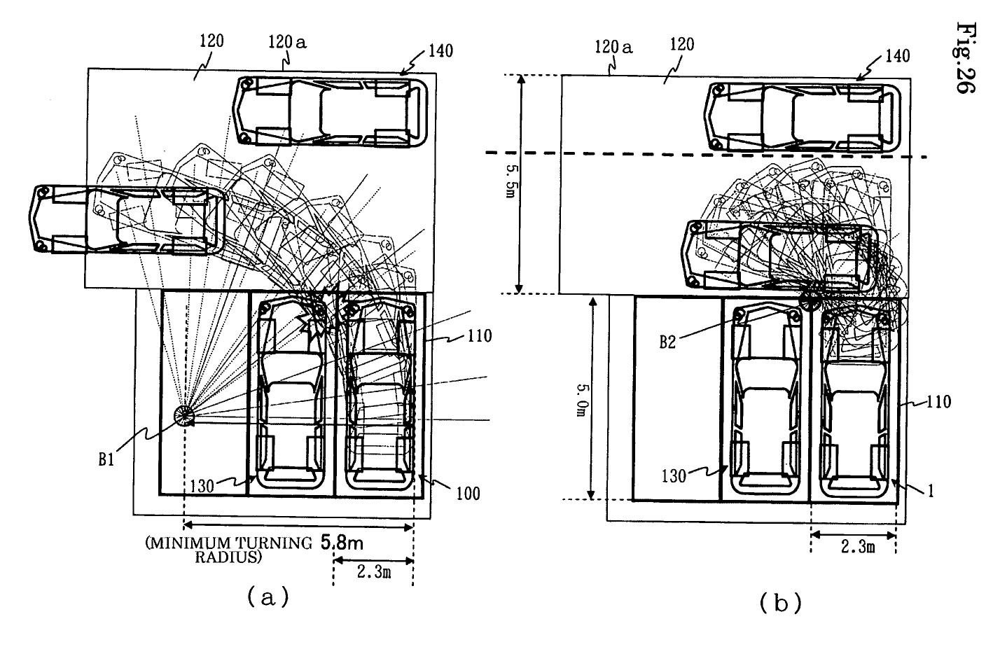

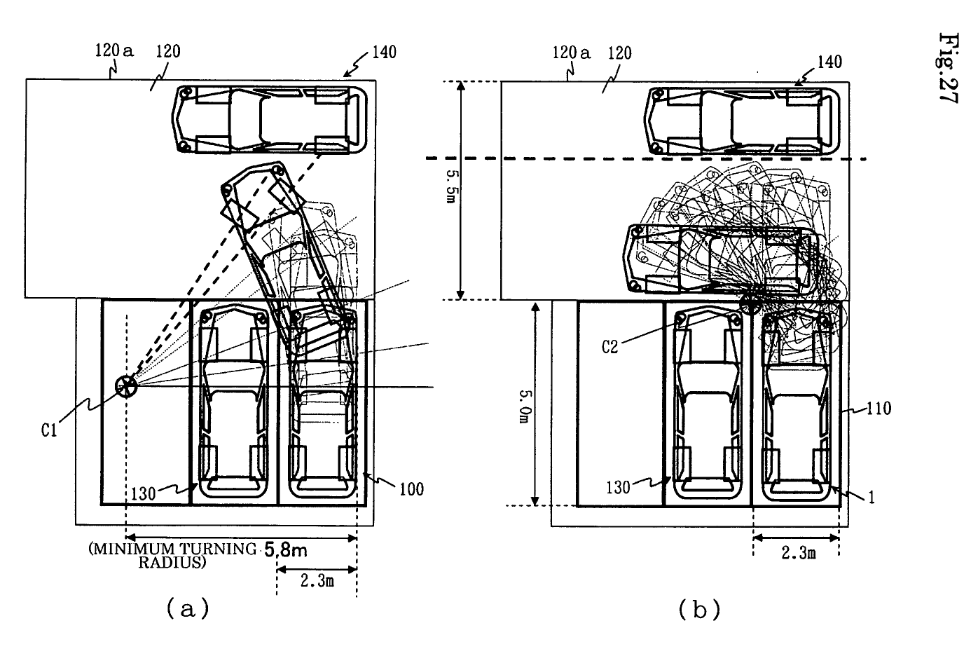

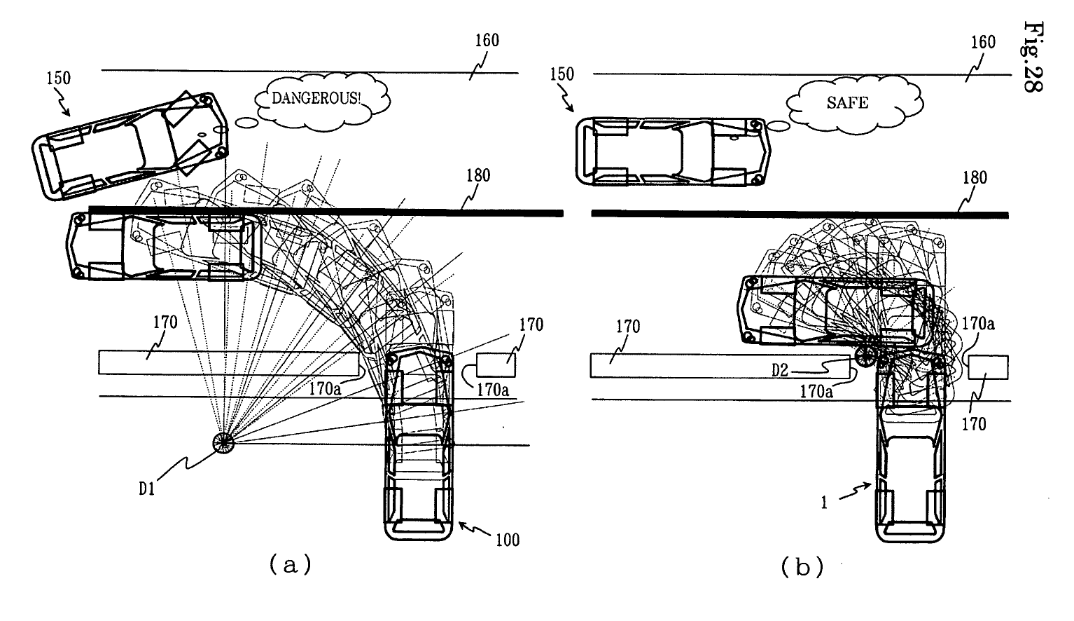

Therefore, when the vehicle 1 is parked in the parking space 110 (see FIG. 26B), the adjacent parking space can be recognized as an obstacle. If the vehicle 1 is to make a turn to drive onto the roadway 160 (see FIG. 28B), the center line 180 can be recognized as an obstacle. As to be explained hereinafter, in the turning control process (FIG. 22), a turning axis is selected to avoid the obstacles. Therefore, by recognizing the adjacent parking space or the center line 180 as an obstacle, the vehicle 1 can make a turn safely without causing a scrape or a collision.

After step S803, it is determined if there is a road in the area surrounding the current position of the vehicle 1 (step S804). If there is a road (Yes at step S804), information about the road width (the entire width of the road, and the width of a one-way lane) is obtained by referring to the map data stored in the map DB 75a (step S805), and the system control proceeds to step S806. If there is no road (No at step S804), step 805 is skipped, and the system control proceeds to step S806.

At step S806, the movable area map is created. Upon completion of step S806, the environment recognizing process (step S702) ends.

At step S806, the movable area map is created from the premise shape information obtained at step S802, the obstacle information obtained at step S803, and the road width information obtained at step S805, when applicable. The map (movable area map) is basically created by excluding the obstacles indicated by the obstacle information from the area of the premise surrounding the current position of the vehicle 1. When there is a road around the current position of the vehicle 1, the lanes legally prohibited to drive (in Japan, right lanes in the driving direction with respect to the center line) are excluded from the area allowed to drive (movable area).

Explanation continues referring back to FIG. 22. After completion of step S702, it is determined if the driver has turned the steering wheel 51 to the left (step S703). If it is left (Yes at step S703), the parameter M1 is set with the value “L” and the system control proceeds to step S705.

At step S703, it is determined that the driver has turned the steering wheel 51 to the right (No (right) at step S703), the parameter M1 is set with “R” (step S718), and the system control proceeds to step S705.

At step S705, it is determined if the turn can be made with a normal two-wheel drive, that is, by the driver operating the steering wheel 51 and the gas pedal 53, on the movable area map obtained at the environment recognizing process (step S702). In other words, at step S705, it is determined if the vehicle 1 can make a turn by turning the steering wheel 51 on the movable area map.

If it is determined at step S705 that a turn by the normal two-wheel drive is not possible (No at step S705), it is further determined if the driving direction is to the front (forward), in other words, the forward switch 42 is pressed (turned on) (step S706).

If it is determined that the driving direction is forward (Yes at S706 (forward)), the parameter M2 is set with the value “F” (step S707), and the parameter Y is set with “0” (step S708).

If it is determined that the driving direction is backward (No at S706 (backward)), in other words, the backward switch 44 is pressed (turned on), the parameter M2 is set with the value “B” (step S720), and the system control proceeds to step S708.

After completing step S708, 4 bytes of data, indicating the x-direction protruding length Ex and the y-direction protruding length Ey, are read from an address obtained by adding a value Y×4 to the initial address pointed by the values of the parameters M1 and M2 (step S709). In other words, the x-direction protruding length Ex and the y-direction protruding length Ey corresponding to the driving direction and turning direction are read from the turn controlling tables 72b (72b11, 72b12, 72b21, 72b22). For example, it is assumed herein that the value in the parameter M1 is “L”, the value in the parameter M2 is “F” and that the parameter Y is “0”. These values points to the initial address of the front-left turn controlling table 72b11. Because the turning axis No. 1FL is recorded at this address, the x-direction protruding length Ex and the y-direction protruding length Ey corresponding to the turning axis No. 1FL are read. If it is assumed the value in the parameter M1 is “L”, the value in the parameter M2 is “F”, and the parameter Y is “1”, then these values points to the turning axis No. 2FL in the front-left turn controlling table 72b11. Therefore, the x-direction protruding length Ex and the y-direction protruding length Ey corresponding to the turning axis No. 2FL are read.

After completing step S709, the read x-direction protruding length Ex and the y-direction protruding length Ey are checked against the movable area map obtained at the environment recognizing process (step S702) to inspect if the vehicle 1 can make a turn (step S710) with the selected turning axis. At step S710, the inspection thereof is made by virtually moving the vehicle 1 in the driving direction from the current position to the position to start making a turn. The position to start making a turn may be defined by latitude and longitude calculated from the latitude and longitude of the current position the vehicle 1 obtained by the GPS, or may also be a position obtained relatively by calculation using the images captured by the in-vehicle cameras 48.

After completing step S710, it is determined if the vehicle 1 can make a turn with the inspected turning axis at step S711 (step S711). If yes, (Yes at step S711), the turning axis number thereof and the information about the position to start making the turn, which is obtained in the inspection, is stored in the candidate memory 73b (step S712), and it is determined if the value of the parameter Y is “19” (step S713).

If it is determined at step S711 that the vehicle 1 cannot make a turn with the inspected turning axis (No at step S711), step S712 is skipped, and the system control proceeds to step S713.

If it is determined at step S713 that the value in the parameter Y is not “19” (No at step S713), value “1” is added to the parameter Y (S721), and the system control proceeds to step S709. If it is determined that the value in the parameter Y is “19” at step S713 (Yes at step S713), it means that inspections have been done for all of the twenty turning axes recorded in the turn controlling tables 72b (72b11, 72b12, 72b21, 72b22), which correspond to the driving direction and turning direction, as to whether it is possible to turn the vehicle 1 therearound. Therefore, it is checked if there is any candidate turning axes stored in the candidate memory 73b (step S714).

If it is determined at step S714 that there are candidates in the candidate memory 73b (Yes at step S714), a turning axis that allows the safest turn is selected from the candidates in the candidate memory 73b (step S715). For example, “a turning axis to allow the safest turn” is determined as one that allows a vehicle 1 to turn with a sufficient space, when checked against the movable area map. Or, it could also be a turning axis that enables the vehicle 1 to turn with a most gradual swept path. As a result of step S715, the vehicle 1 is turned with a turning axis that is safest to make a turn. In this manner, the vehicle 1 can make a turn safely without causing collision or scraping.

After completion of step S715, the driving control process is executed (step S716), and the turning control process ends. In the driving control process at step S716, the vehicle 1 is moved forward or backward to the position to start making a turn with the turning axis selected at step S715. Subsequently, the controlling apparatus 100 controls the wheel driving unit 3 and the actuator unit 4 so as to turn the vehicle 1 around the selected turning axis. In the driving control process at step S716, it is determined if the vehicle 1 is moved to the starting position by measuring the position using GPS when the starting position is specified by latitude and longitude. Or, it may also be determined based on the images captured by the in-vehicle cameras 48.

If it is determined at step S714 that there is no candidate in the candidate memory 73b (No at step S714), a notice is displayed on the LCD 50 to inform the driver that there is no candidate (step S722), and the turning control process ends. The driver can recognize that it is difficult to make a turn from the notice on the display, and make a turn by turning the steering wheel 51 back and forth, or take some other measures.

If it is determined at step S701 that the vehicle 1 is not parked (No at step S701), a notice is displayed on the LCD 50 so as to prompt the driver to stop the vehicle 1 (step S717), and the turning control process ends. The driver can stop the vehicle 1 by recognizing the notice on the display, and execute the turning control process again.

If it is determined at step S705 that the turn can be made with a normal two-wheel drive (Yes at step S705), a notice is displayed on the LCD 50 to inform the driver that the turn can be made with the two-wheel drive, and the turning control process ends. The driver then can make a turn with the normal two-wheel drive.

In other words, if it is determined at step S705 that the turn can be made with a normal two-wheel drive, the normal two-wheel drive (with two-wheel steering) is prioritized. When each wheel 2 is independently steered and rotated, each wheel 2 often slips in rotation. Therefore, the wheels 2 wear out more, when compared with a turn made by a normal two-wheel drive. Therefore, if the environment surrounding the vehicle 1 allows the driver to make a turn by operating the steering wheel 51 and the gas pedal 53, wear of the wheels 2 can be suppressed by prioritizing the turn by the two-wheel drive.

As described above, according to the eleventh embodiment of the present invention, an appropriate turning axis (a vehicle turning pattern) is searched so as to allow the vehicle 1 to make a turn in the environment surrounding thereof. Therefore, even when it is difficult for the driver to make a turn by operating the steering wheel 51 and the gas pedal 53 because of the environment surrounding the vehicle 1, or the area is limited, the controlling apparatus 100 controls the vehicle 1 to steer and rotate each wheel 2 independently so as to make a turn around the searched turning axis. As a result, the vehicle 1 can make an appropriate turn depending on the environment surrounding thereof. Because it does not require the driver to turn the steering wheel 51 back and forth, the vehicle 1 can be turned safely and easily.

Furthermore, the controlling apparatus 100 controls each wheel 2 to be steered and rotated independently so as to make a turn around an appropriate turning axis. Therefore, each wheel 2 can be steered and rotated without a burden to the driver. As a result, the vehicle 1 can be turned appropriately.

Furthermore, according to the eleventh embodiment of the present invention, it is determined that there is any turning axis that enables the vehicle 1 to be turned out of the twenty representative turning axes recorded in the turn controlling tables 72b in advance. Therefore, an appropriate or most appropriate turning axis can be selected with a small control overhead, allowing a vehicle 1 to be turned using the appropriate or most appropriate vehicle turning pattern.

It is also possible to allow a driver to select a preferable turning method between a normal two-wheel drive (normal turn with two-wheel steering) and an “ad hoc” turn (a turn made by the driving control process of step S716).

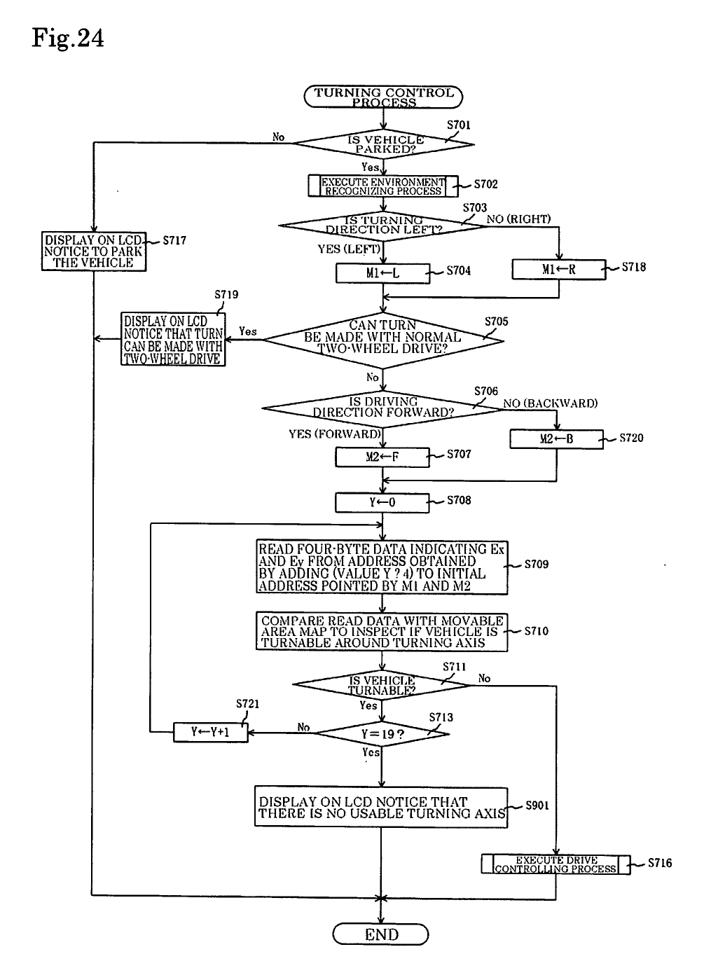

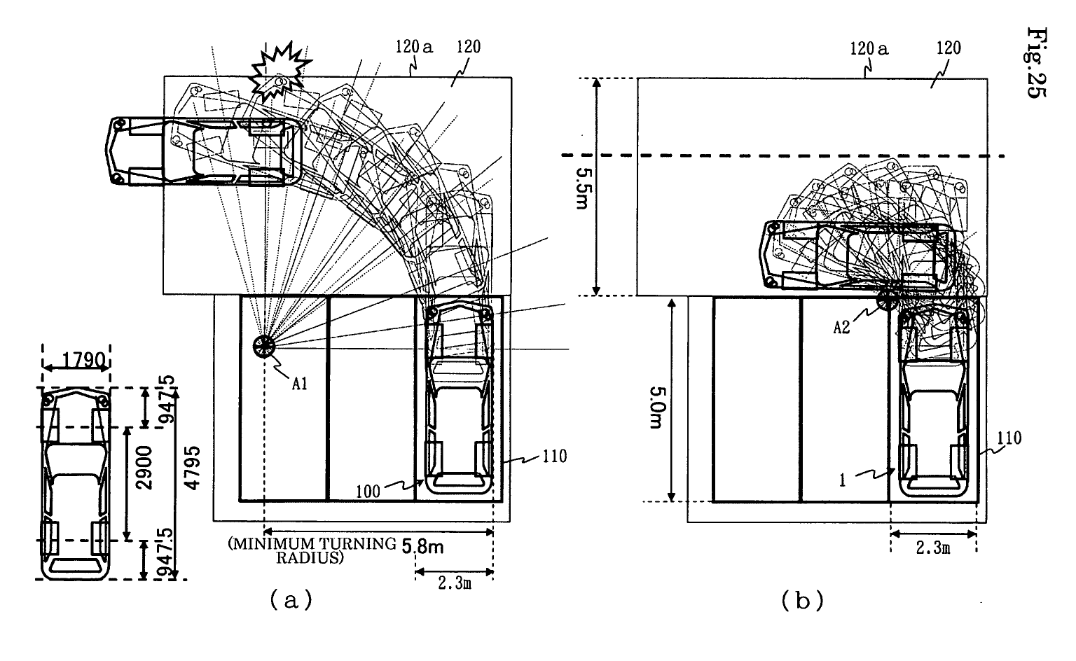

A twelfth embodiment of the present invention is explained herein with reference to FIG. 24. According to the eleventh embodiment described above, all of the twenty turning axes, recorded in the turn controlling tables 72b (72b11, 72b12, 72b21, 72b22), are inspected if the vehicle 1 can be turned therearound, and the most appropriate turning axis is selected from the ones that are determined applicable.

Instead, according to the twelfth embodiment of the present invention, the vehicle 1 is turned around the first turning axis, out of twenty recorded in the turn controlling tables 72b (72b11, 72b12, 72b21, 72b22), that is found applicable. The elements that are the same as in the first embodiment of the present invention are given the same reference numbers, and explanations thereof are omitted herein.

FIG. 24 is a flowchart for showing a turning control process according to the twelfth embodiment of the present invention. As shown in FIG. 24, steps S701 to S711 are executed in the same manner as in the eleventh embodiment. If it is determined that the vehicle 1 can make a turn with the inspected turning axis at step S711 (Yes at step S711), the driving control process is executed to move the vehicle 1 to the position to start the vehicle, the position information obtained in the inspection, and to turn the vehicle 1 around the turning axis (step S716). Then, the turning control ends.

After completion of step S711, step S713 is executed to check if the value in the parameter Y is “19”. If it is “19” (Yes at step S713), a notice is displayed on the LCD 50 so as to inform the driver that there is no turning axis that allows the vehicle 1 to be turned (step S901), and the turning control process ends.

As explained above, according to the twelfth embodiment of the present invention, when a turning axis is found to allow turning of a vehicle 1 with respect to the surrounding environment, other turning axes are not searched any further, and the controlling apparatus 100 controls the actuator unit 4 and the wheel driving unit 3 so as to turn the vehicle 1 around the selected turning axis. In this manner, not only the control overhead is reduced, but also the turning axis (or the vehicle turning patterns) can be searched faster. As result, the time lag before starting to turn the vehicle 1 is reduced, allowing the vehicle 1 to be turned quickly.

To execute the turning control process according to the twelfth embodiment of the present invention, the twenty turning axes should be recorded in the turn controlling tables 72b (72b11, 72b12, 72b21, 72b22) in advance in the order of favorability, from one with most advantageous conditions to the least advantageous one. In this manner, the first appropriate turning axis found applicable will be the most favorable. For example, the turning axes may be recorded in the turn controlling tables 72b (72b11, 72b12, 72b21, 72b22) from one with least worn wheels 2 down to the one with most worn wheel 2. In this manner, a turn is made using least worn wheels 2. In this manner, further wear of the wheels 2 can be suppressed.

The environment information obtaining section mentioned in claim 7 corresponds to the environment recognizing process (step S702), the vehicle turning pattern searching section mentioned therein corresponds to steps S703 to S713, S718, S720, and S721, and the turn controlling section mentioned therein corresponds to the driving control process (step S716).

The comparing section mentioned in claim 8 corresponds to step S710. A driver-operated turnability determining section mentioned in claim 9 corresponds to step S705, and the search prohibiting section mentioned therein corresponds to the branched process of Yes at step S705.

The vehicle position obtaining section mentioned in claim 10 corresponds to step S801, the premise-shape recognizing section mentioned therein corresponds to step S802, the movable area detecting section mentioned therein corresponds to step S806. The obstacle information obtaining section mentioned in claim 11 corresponds to step S803.

The present invention is explained herein based on the embodiments thereof. However, the embodiments herein are not intended to limit the scope of the present invention, and it should be obvious for those skilled in art that many variations thereof are possible without deviating from the purpose of the present invention.

For example, the values mentioned herein are just examples, and it should be obvious that other values may also be used.

According to the embodiments described above, images captured by the in-vehicle cameras 48, arranged at the front, rear, right, and left of the vehicle 1, are used to obtain information about the obstacle in proximity to the vehicle 1. It is also possible to provide a fisheye lens on top of the vehicle roof, so as to allow capturing of the image around the vehicle 1 for 360 degrees. Alternatively, more than four in-vehicle cameras 48 may be used to obtain comprehensive obstacle information.

Instead of the in-vehicle cameras 48, an object-detecting apparatus, such as a sensor or radar, may also be used to obtain the obstacle information. It is advantageous to obtain the obstacle information using an object-detecting apparatus, such as a sensor or radar, because it is possible to obtain information that is difficult to obtain from a static image (for example, information about other approaching vehicles on the road). It is also possible to obtain the obstacle information using both the in-vehicle cameras 48 and an object-detecting apparatus.

If a turning axis, which allows a vehicle to make a turn, cannot be found using the obstacle information obtained from the in-vehicle camera 48, it is also possible to search a turning axis by creating a movable area map from the obstacle information obtained from the object-detecting apparatus. As described above, the obstacle information obtained from the image captured by the in-vehicle cameras 48 includes information that cannot be detected by an object-detecting apparatus, such as a sensor or a radar (for example, a boundary line of the parking space or a center line). Therefore, if the obstacle information is obtained from the in-vehicle cameras 48, a stricter requirement will be used upon finding an applicable turning axis, compared with a scenario using the obstacle information obtained by the object-detecting apparatus. Thus, if a usable turning axis cannot be found using the in-vehicle cameras 48, the requirement can be loosened by using the obstacle information obtained from the object-detecting apparatus, increasing the possibility to find a usable turning axis.

According to the embodiments described above, the turning control process (FIG. 21) may be triggered by the steering wheel 51 being turned. Alternatively, a turn-signal by a turn-signal lever (not shown) may also be used as a trigger. Another alternative is to provide a left-turn and a right-turn switch. A turning direction specified by a traffic rule, such as one-way street included in the map DB, may also be recognized as a turnable direction.

According to the embodiments described above, the vehicle turning pattern includes the x-direction protruding length Ex and the y-direction protruding length Ey. Alternatively, it is possible to use more detailed data about a vehicle turning swept path to check against the movable area map. Another alternative is to calculate a swept path corresponding to each of an infinite number of turning axes, and check against the movable area map.

1. A controlling apparatus that controls a vehicle having a plurality of steerable wheels, an actuator unit that drives to steer each of the steerable wheels independently, and a wheel driving unit that drives to rotate each of the steerable wheels independently, and the vehicle being moved in a given direction by operating the actuator unit and the wheel driving unit to control steering and rotation of the steerable wheels, the controlling apparatus comprising:
a first operating section that operates the actuator unit so as to give at least one of the steerable wheels a steering angle; and
a second operating section that operates the wheel driving unit so as to drive to rotate at least two of the steerable wheels including the wheel to which the steering angle is given, and rotate at least one of the steerable wheels in a forward direction, and at least another of the steerable wheels in a reverse direction; wherein
the vehicle is controlled to move in a direction toward an angle that is at least larger than the maximum steerable angle of the wheels by combining a longitudinal vector component and a lateral vector component of a driving force generated by driving to rotate the wheels.

2. The controlling apparatus according to claim 1, wherein the second operating section operates the wheel driving unit so that a sum of the lateral vector component of the driving force generated by at least two of the wheels that are driven to rotate by the wheel driving unit exceeds 0, and a sum of the longitudinal vector component thereof becomes 0.

3. The controlling apparatus according to claim 2, wherein
the steerable wheels comprise a front-right wheel, a front-left wheel, a rear-right wheel, and a rear-left wheel;
the first operating section operates the actuator unit so as to give at least one of the front-right and front-left wheels and at least one of the rear-right and rear-left wheels the steering angle; and
the second operating section operates the wheel driving unit so that the lateral vector component of a driving force generated by the front-right and front-left wheels becomes the same in magnitude and direction as the lateral vector component of a driving force generated by the rear-right and rear-left wheels, and that the longitudinal vector component of a driving force generated by the front-right and front-left wheels becomes the same in magnitude but different in direction as the longitudinal vector component of a driving force generated by the rear-right and rear-left wheels.

4. The controlling apparatus according to claim 2, wherein
the steerable wheels comprise a front-right wheel, a front-left wheel, a rear-right wheel, and a rear-left wheel;
the wheel driving unit is driven so that
a lateral vector component of a driving force generated by one of either the front-right and front-left wheels or the rear-right and rear-left wheels becomes greater in magnitude in the same or a different direction than a lateral vector component of a driving force generated by the other of either the front-right and front-left wheels or the rear-right and rear-left wheels;
a longitudinal vector component of the driving force generated by one of either the front-right and front-left wheels or the rear-right and rear-left wheels becomes greater in magnitude in a different direction than a longitudinal vector component of a driving force generated by the other of either the front-right and front-left wheels or the rear-right and rear-left wheels; and
the lateral vector component of the driving force generated by the front-right wheel, the front-left wheel, the rear-right wheel, and the rear-left wheel to spin the vehicle in rotation is cancelled out by the longitudinal vector component of the driving force generated by the front-right wheel, the front-left wheel, the rear-right wheel, and the rear-left wheel.

5. The controlling apparatus according to claim 1, further comprising:
a detecting section that detects usage frequency of the steerable wheels;
a determining section that determines if the usage frequency detected by the detecting section exceeds a reference value; and
a prohibiting section that prohibits any wheel whose usage frequency is determined to exceed the reference value by the determining section from being driven in rotation via an operation of the wheel driving unit by the second operation section.

6. A vehicle comprising:
a plurality of steerable wheels;
an actuator unit that steers each of the steerable wheels independently;
a wheel driving unit that drives to rotate each of the steerable wheels independently; and
the controlling apparatus according to claim 1.

7. A controlling apparatus that controls an actuator unit that drives to steer a plurality of steerable wheels of a vehicle independently, the controlling apparatus comprising:
an environment information obtaining section that obtains information about the environment surrounding the vehicle;
a turning pattern searching section that searches a turning axis and a turning pattern for turning the vehicle based on the environment information obtained by the environment information obtaining section; and
a turn controlling section that controls the actuator unit so that the vehicle is turned around the turning axis following the turning pattern, both of which are searched by the turning pattern searching section.

8. The controlling apparatus according to claim 7, further comprising:
a turning pattern storage section that stores a plurality of turning patterns; and
a comparing section that compares the turning patterns stored in the turning pattern storage section with the environment information obtained by the environment information obtaining section; wherein
the turning pattern searching section searches a turning pattern from the turning pattern storage section based on a comparison result obtained by the comparing section.

9. The controlling apparatus according to claim 8, further comprising:
a driver-operated turnability determining section that determines if the vehicle is turnable under the environment information obtained by the environment information obtaining section by steering at least some of the wheels by an angle determined by a driver steering a steering wheel, and by applying a driving force determined by the driver operating a gas pedal to at least some of the wheels; and
a search prohibiting section that prohibits the turning pattern searching section from searching the turning axis and the turning pattern when the driver-operated turnability determining section determines that the vehicle is turnable by the driver operating the steering wheel and the gas pedal.

10. The controlling apparatus according to claim 7, further comprising:
a vehicle position obtaining section that obtains information about the position of the vehicle;
a map data storage section that stores therein a map data;
a premise-shape recognizing section that recognizes the shape of an area surrounding the vehicle whose position information is obtained by the vehicle position obtaining section, based on the map data stored in the map data storage section; and
a movable area detecting section that detects an area available for the vehicle to track based on the shape of the premise recognized by the premise-shape recognizing section; wherein
the environment information obtaining section obtains the movable area detected by the movable area detecting section as the environment information.

11. The controlling apparatus according to claim 7, further comprising:
an obstacle information obtaining section that obtains information about obstacles existing in proximity to the vehicle, wherein
the environment information obtaining section obtains the obstacle information detected by the obstacle information obtaining section as the environment information.

12. The controlling apparatus according to claim 7, further comprising:
a road width storage section that stores therein road width information, wherein
the environment information obtaining section uses the road width information stored in the road width storage section as the environment information.

13. A vehicle comprising:
a plurality of steerable wheels;
an actuator unit that drives to steer each of the steerable wheels independently;
a wheel driving unit that drives to rotate each of the steerable wheels independently; and
the controlling apparatus according to claim 7.

14. The controlling apparatus according to claim 1, wherein
the steerable wheels comprise a front-right wheel, a front-left wheel, a rear-right wheel, and a rear-left wheel;
the first operating section operates the actuator unit so as to give at least one of the front-right and front-left wheels and at least one of the rear-right and rear-left wheels the steering angle; and
the second operating section operates the wheel driving unit so that the lateral vector component of a driving force generated by the front-right and front-left wheels becomes the same in magnitude and direction as the lateral vector component of a driving force generated by the rear-right and rear-left wheels, and that the longitudinal vector component of a driving force generated by the front-right and front-left wheels becomes the same in magnitude but different in direction as the longitudinal vector component of a driving force generated by the rear-right and rear-left wheels.

15. The controlling apparatus according to claim 1, wherein
the steerable wheels comprise a front-right wheel, a front-left wheel, a rear-right wheel, and a rear-left wheel;
the wheel driving unit is driven so that
a lateral vector component of a driving force generated by one of either the front-right and front-left wheels or the rear-right and rear-left wheels becomes greater in magnitude in the same or a different direction than a lateral vector component of a driving force generated by the other of either the front-right and front-left wheels or the rear-right and rear-left wheels;
a longitudinal vector component of the driving force generated by one of either the front-right and front-left wheels or the rear-right and rear-left wheels becomes greater in magnitude in a different direction than a longitudinal vector component of a driving force generated by the other of either the front-right and front-left wheels or the rear-right and rear-left wheels; and
the lateral vector component of the driving force generated by the front-right wheel, the front-left wheel, the rear-right wheel, and the rear-left wheel to spin the vehicle in rotation is cancelled out by the longitudinal vector component of the driving force generated by the front-right wheel, the front-left wheel, the rear-right wheel, and the rear-left wheel.

16. The controlling apparatus according to claim 7, further comprising:
a driver-operated turnability determining section that determines if the vehicle is turnable under the environment information obtained by the environment information obtaining section by steering at least some of the wheels by an angle determined by a driver steering a steering wheel, and by applying a driving force determined by the driver operating a gas pedal to at least some of the wheels; and
a search prohibiting section that prohibits the turning pattern searching section from searching the turning axis and the turning pattern when the driver-operated turnability determining section determines that the vehicle is turnable by the driver operating the steering wheel and the gas pedal.

17. The controlling apparatus according to claim 2, further comprising:
a detecting section that detects usage frequency of the steerable wheels;
a determining section that determines if the usage frequency detected by the detecting section exceeds a reference value; and
a prohibiting section that prohibits any wheel whose usage frequency is determined to exceed the reference value by the determining section from being driven in rotation via an operation of the wheel driving unit by the second operation section.

18. The controlling apparatus according to claim 3, further comprising:
a detecting section that detects usage frequency of the steerable wheels;
a determining section that determines if the usage frequency detected by the detecting section exceeds a reference value; and
a prohibiting section that prohibits any wheel whose usage frequency is determined to exceed the reference value by the determining section from being driven in rotation via an operation of the wheel driving unit by the second operation section.

19. The controlling apparatus according to claim 4, further comprising:
a detecting section that detects usage frequency of the steerable wheels;
a determining section that determines if the usage frequency detected by the detecting section exceeds a reference value; and
a prohibiting section that prohibits any wheel whose usage frequency is determined to exceed the reference value by the determining section from being driven in rotation via an operation of the wheel driving unit by the second operation section.

20. A vehicle comprising:
a plurality of steerable wheels;
an actuator unit that steers each of the steerable wheels independently;
a wheel driving unit that drives to rotate each of the steerable wheels independently; and
the controlling apparatus according to claim 2.
